(19) United States
(12) Patent Application Publication
(10) Pub. No.: US 2025/0301285 A1
(43) Pub. Date: Sep. 25, 2025

(54) RADIO RESOURCE MANAGEMENT USING MACHINE LEARNING

(71) Applicant: GOOGLE LLC, Mountain View, CA (US)

(72) Inventors: Jibing Wang, San Jose, CA (US); Erik Richard Stauffer, Sunnyvale, CA (US)

(21) Appl. No.: 18/863,042

(22) PCT Filed: May 3, 2023
(86) PCT No.: PCT/US2023/020767

§ 371 Date: Nov. 5, 2024

Related U.S. Application Data
(60) Provisional application No. 63/340,187, filed on May 10, 2022.

(51) Int. Cl. H04W 4/38; H04L 41/16; H04W 8/22; H04W 36/38; H04W 76/20

(52) U.S. Cl. CPC H04W 4/38; H04L 41/16; H04W 8/22; H04W 36/38; H04W 76/20

(57) ABSTRACT

A wireless device is configured to receive a set of sensor data from one or more sensors of the wireless device, receive a set of radio measurements from a radio interface of the wireless device, process the set of sensor data and the set of radio measurements at a radio resource management (RRM) neural network of the wireless device to generate an output representative of an RRM action, and then perform the RRM action. The wireless device further can provide a representation of sensor capabilities of the wireless device for receipt by an infrastructure component of a network infrastructure that is wirelessly connected to the wireless device, receive a neural network architectural configuration from the infrastructure component in response to providing the representation of sensor capabilities, and implement the neural network architectural configuration at the RRM neural network.

### BACKGROUND

Cellular networks and other wireless networks often employ radio resource management (RRM) to manage network capacity issues at a large-scale level (e.g., multiple-user or multiple-cell level), rather than addressing point-to-point network capacity issues. RRM thus utilizes a wide range of techniques to provide efficient overall network throughput while seeking efficient power consumption on the part of the various networked components. These techniques can include, for example, techniques directed to power control, scheduling, cell search, cell reselection, handover, radio link or connection monitoring, connection establishment/re-establishment, co-interference management, and the like. The user equipment (UE) in a wireless network often plays a substantial role in RRM, such as through the collection of various radio measurements and other system observations for reporting to the network for use in implementing network-side RRM actions, as well as implementing certain procedures based on these measurements. In conventional approaches, a serving base station (BS) or other component of the network infrastructure directs a UE to employ a static, or algorithmic, configuration for the UE's role in the overall RRM process, such as by configuring the UE to employ a static schedule for intra-frequency, inter-frequency, or inter-RAT (radio access technology) scanning of the serving cell or neighboring cells, or by specifying a particular algorithm or a fixed set of thresholds for use by the UE in making a conditional handover decision (CHO) for switching between cells. This static approach to configuring a UE's role in RRM often fails to account for the UE's particular circumstances, and thus may result in non-optimal RRM behavior at the UE. This often leads to the inefficient acquisition of RRM-related information at the UE, and thus may impair the overall RRM decision process that utilizes such information. A non-optimal RRM configuration for the UE also can result in unnecessary power consumption at the UE as the UE performs various RRM actions that are less relevant to, or less timely for, the overall efficiency of the RRM process.

### BRIEF DESCRIPTION OF THE DRAWINGS

The present disclosure is better understood, and its numerous features and advantages made apparent to those skilled in the art by referencing the accompanying drawings. The use of the same reference symbols in different drawings indicates similar or identical items.

FIG. 1 is a diagram illustrating an example wireless system employing a neural-network-based RRM management at a wireless device in accordance with some embodiments.

FIG. 2 is a diagram illustrating example configurations of a wireless device implementing a neural network for UE-side RRM management in accordance with some embodiments.

FIG. 3 is a diagram illustrating example configurations of an infrastructure component implementing a UE neural network selection and update scheme in accordance with some embodiments.

FIG. 4 is a diagram illustrating a machine learning module employing a neural network for use in a neural-network-based sensor and transceiver fusion scheme in accordance with some embodiments.

FIG. 5 is a diagram illustrating an example operating environment for an RRM scheme at a wireless device in accordance with some embodiments.

FIG. 6 is a diagram illustrating an example operating environment for an RRM scheme at an infrastructure component in accordance with some embodiments.

FIGS. 7 and 8 together illustrate a flow diagram for an example method for configuration and implementation of an RRM neural network at a wireless device in accordance with some embodiments.

FIG. 9 is a ladder diagram illustrating an example of the method of FIGS. 7 and 8.

FIG. 10 is a flow diagram illustrating an alternative implementation of the method of FIGS. 7 and 8 in accordance with some embodiments.

FIG. 11 is a flow diagram illustrating an example method for configuration and implementation of a Conditional Handover (CHO) neural network at a wireless device for management of CHO decision making at the wireless device in accordance with some embodiments.

FIG. 12 is a ladder diagram illustrating an example of the method of FIG. 11 in accordance with some embodiments.

### DETAILED DESCRIPTION

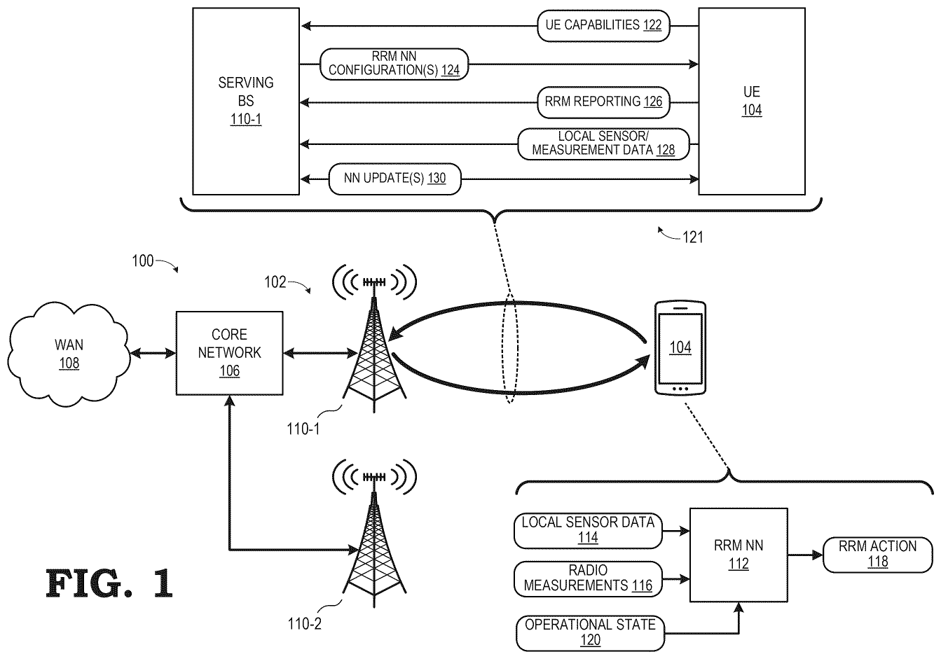

The static or algorithmic configuration of a UE for RRM operations as found in many conventional wireless systems can lead to less effective UE utilization for the overall RRM process at the cost of excessive power consumption at the UE. Further, configuring a UE to employ these static RRM configurations typically requires considerable design, test, and implementation efforts. As described below with reference to FIGS. 1-12, static or algorithmic approaches to UE-side RRM operations can be replaced by, or supplemented by, neural network (NN)-based approaches that operate to fuse sensor data from available sensors of the UE with radio measurements made by the UE to arrive at one or more RRM actions to be employed by the UE. Such actions can include, for example, the configuration of the frequency or type of radio measurements to be performed, the determination of certain conditional RRM actions (such as a conditional handover (CHO) decision or conditional Primary Cell Change (CPC)), the performance of a particular type of measurement or other RRM action, and the like.

In at least one embodiment, a base station (BS) (or other infrastructure component) is provided access to a set of neural network architectural configurations that have been trained using various training data sets that reflect different sensor capabilities, different sensor data, different RRM-related measurements made by a UE or other wireless device, and the like. During or after the establishment of a wireless connection between the BS and the UE, the UE supplies the BS with a representation of its sensor capabilities, or in particular, the sensor capabilities relevant to the sensor types used to train the neural network architectural configurations accessible to the BS. The BS then selects a neural network architectural configuration based on the indicated sensor capabilities of the UE and directs the UE to implement the selected neural network architectural configuration at an RRM neural network (e.g., a deep neural network (DNN)) of the UE.

With the UE so configured, the UE captures and supplies a series of one or more sensor measurements from a set of sensors as a set of sensor data to the RRM neural network. Likewise, the UE captures and supplies, via a radio interface distinct from the set of sensors, a series of one or more radio measurements (also referred to as radio parameters or radio metrics), such as signal power measurements, of one or both of the serving cell or one or more target or neighboring cells, as a set of radio measurements to the RRM neural network. The RRM neural network then uses these inputs to generate an output that represents one or more RRM actions to be taken by the UE in response to these input data sets. The RRM action specified by the output of the RRM neural network can include direction to take a particular RRM action, such as to take a specified RRM-related measurement or direction to implement a CHO decision (e.g., to initiate handover to a target cell, or conversely, to hold off on any handover) or direction to refrain from taking a particular RRM action. The RRM action also or alternatively can include configuration of an aspect of an RRM action, such as configuring the frequency at which a particular RRM action is performed (e.g., the frequency of checking for data when in a connected state or the frequency at which cell reselection is evaluated when in an idle state), configuring the parameters employed for the RRM action (e.g., specifying a particular frequency band to be used for inter-frequency measurement), and the like.

Further, the UE can report one or both of the sensor data or radio measurements used by the RRM neural network in determining the resulting RRM action to the BS, which can then use this feedback to re-train a model or copy of the RRM neural network and provide the UE with an updated version of the RRM neural network for subsequent use. Alternatively, the UE can utilize this same data and other information to re-train or modify its local copy of the RRM neural network.

The incorporation, or fusion, of recent local sensor data of the UE along with recent radio measurements by the RRM neural network facilitates the local RRM processes employed by the UE to more readily adapt to the present transmission environment or other present circumstances of the UE than would be provided via a static/algorithmic RRM configuration for the UE. For example, as a result of the training of the implemented neural network architecture, sensor data indicating the proximity of a body, building, or other interferer may trigger the RRM neural network to dictate an RRM action that reduces the frequency at which certain measurements are made using a millimeter-wave (mmW) antenna of the UE (and thereby saving power) or may trigger the RRM neural network to employ a lower threshold for a signal power parameter measured via the mmW antenna before triggering a CHO, and thus potentially eliminating an unnecessary handover process. Moreover, by utilizing a neural network with an architectural configuration trained on sensor data consistent with the indicated sensor capabilities of the UE, the UE can effectively implement various UE-side RRM actions without requiring the substantial design, test, and implementation efforts that otherwise would be required for the implementation of conventional static/algorithmic RRM configurations.

The systems and techniques for neural-network-based RRM detailed herein utilize coordination between an infrastructure component and a wireless device of a wireless network. To ease of illustration, these systems and techniques are described in an example context of a cellular network in which a base station (BS) acts as the aforementioned infrastructure component and a UE acts as the aforementioned wireless device. However, these systems and techniques are not limited to this example implementation. For example, in the same cellular context, the infrastructure component could be a server or other component separate from a BS or could involve multiple infrastructure components, such as a cooperating server and BS. As another example, in a wireless local area network (WLAN) implementation, the aforementioned infrastructure component could be the wireless access point (AP) or other component “upstream” from the aforementioned wireless device that is connected to the wireless AP.

FIG. 1 illustrates an example wireless communications network 100 employing a neural-network-based RRM scheme in accordance with some embodiments. In the depicted example, the wireless communication network 100 is a cellular network including a network infrastructure 102 wirelessly connected to one or more wireless devices, such as UE 104. The network infrastructure 102 includes a core network 106 coupled to one or more wide area networks (WANs) 108 or other packet data networks (PDNs), such as the Internet. The core network 106 further is connected to one or more BSs 110, such as BS 110-1 and BS 110-2. Each BS 110 supports wireless communication with one or more wireless devices, such as UE 104, via radio frequency (RF) signaling using one or more applicable RATs as specified by one or more communications protocols or standards. As such, each BS 110 operates as a wireless interface between one or more wireless devices and various networks and services provided by the network infrastructure 102, such as packet-switched (PS) data services, circuit-switched (CS) services, and the like. Conventionally, communication of signaling from the BS 110 to the UE 104 is referred to as “downlink” or “DL” whereas communication of signaling from the UE 104 to the BS 110 is referred to as “uplink” or “UL.”

Each BS 110 can employ any of a variety of RATs, such as operating as a NodeB (or base transceiver station (BTS)) for a Universal Mobile

Telecommunications System (UMTS) RAT (also known as “3G”), operating as an enhanced NodeB (eNodeB) for a Third Generation Partnership Project (3GPP) Long Term Evolution (LTE) RAT, operating as a 5G node B (“gNB”) for a 3GPP Fifth Generation (5G) New Radio (NR) RAT, and the like. The UE 104, in turn, represents any of a variety of electronic devices operable to communicate with the BS 110 via a suitable RAT, including, for example, a mobile cellular phone, a cellular-enabled tablet computer or laptop computer, a desktop computer, a cellular-enabled video game system, a server, a cellular-enabled appliance, a cellular-enabled automotive communications system, a cellular-enabled smartwatch or other wearable device, and the like.

For purposes of the following, in FIG. 1 the BS 110-1 presently is wirelessly connected to the UE 104 and providing network services via the resulting wireless connection, and thus is referred to herein as the “serving” BS 110-1 (which is also known in the art as the “primary” BS). In this example, the BS 110-2 is not presently providing network services to the UE 104 but is available for handover and the commencement of the provision of network services, and thus is referred to as the “target” BS 110-1 (also known in the art as a “neighboring” BS or a “secondary” BS).

Although the example wireless communications network 100 of FIG. 1 depicts only a single UE 104 and two BSs 110 for ease of illustration, in real-world implementation such a wireless system would have numerous BSs and UEs 104 operating in a close geographical region, and thus providing many opportunities for RF interference and contention for shared RF resource or network resources. Accordingly, in at least one embodiment the wireless communications network 100 utilizes an RRM scheme to manage network capacity and network resource contention at a large-scale level. This RRM scheme involves the UE 104, both in taking various measurements that may be utilized for various RRM processes, as well as performing parts or all of some of these RRM processes. As noted above, conventional RRM schemes rely on an algorithmic or static approach to utilizing a UE for RRM-related measurements and actions.

In contrast, in at least one embodiment the wireless communication network 100 utilizes a neural-network-based RRM scheme in which the UE 104 is configured to utilize a trained RRM neural network (NN) 112 to adaptively and non-statically implement RRM actions based on information regarding the present context of the UE 104. In particular, in at least one embodiment the RRM NN 112 receives as separate inputs local sensor data 114 and radio measurements data 116 and from at least these inputs provides an output indicating at least one RRM action 118.

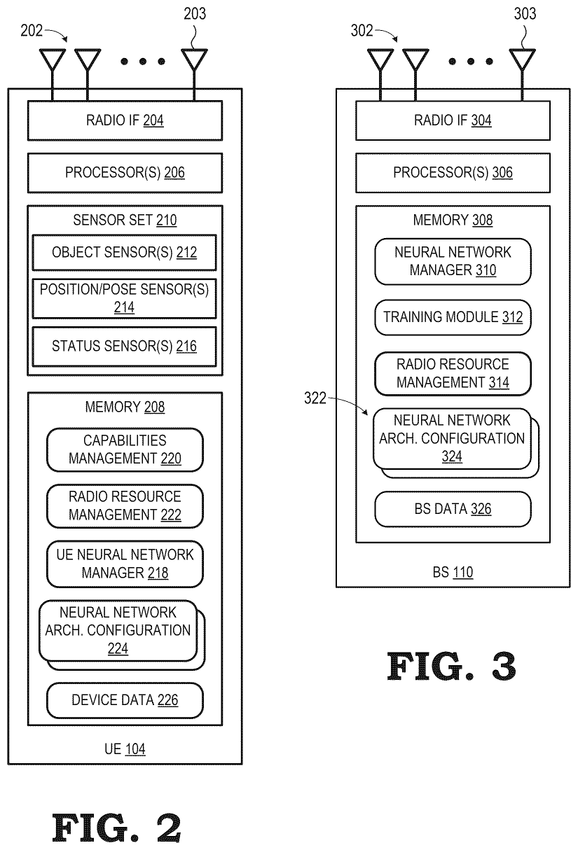

The local sensor data 114 includes sensor data obtained from one or more sensors of a sensor set (see FIG. 2) of the UE 104 and may be provided as a single-time-point sampling of sensor data/sensor status from the involved sensors, or as a time sequence of samplings of sensor data from the involved sensors over a fixed or variable sliding time window. It will be appreciated that the information captured by sensors of the sensor set of the UE 104 can reflect the present operating state of the UE 104, both with reference to the physical local RF transmission environment of the UE 104 as well as with reference to the internal operating status of the UE 104. For example, present conditions involving the UE 104 that have the potential to impair RF signaling between the UE 104 and the serving BS 110-1 (as well as the absence of such conditions) may be detectable from, or otherwise represented in, sensor data generated by, for example, object-detecting sensors, such as radar, lidar, or imagers (e.g., imaging cameras), that generate sensor data that reflects the presence or absence of interfering objects in a line-of-sight (LOS) propagation path between the serving BS 110-1 and the UE 104. Similarly, positioning data, such as from a Global Positioning System (GPS) sensor, gyroscope, accelerometer, or a camera-based visual odometry sensor system, locates one the position and/or motion the UE 104 relative to, for example, the serving BS 110-1, and thus may represent the current RF signal propagation environment. As another example, a light sensor, image sensor, or touch sensor may provide sensor data indicating the pose of the UE 104 relative to the user's body, and thus serve as an indication of the likely present RF signal propagation environment for the UE 104. As for the present internal operating environment of the UE 104, a battery power sensor may indicate the amount of battery power remaining and thus indicate the UE's capability to continue to perform various tasks without impairing overall operation of the UE 104, while a thermal sensor of the UE 104 may indicate whether the UE 104 is close to a thermal limit and thus indicate the degree to which the UE 104 can continue to perform various RRM actions that may contribute to the thermal output of the UE 104. Thus, the input of the local sensor data 114 to the trained RRM NN 112 can facilitate the decision-making process of the RRM NN 112 to adapt the resulting input to reflect the present operating environment of the UE 104.

As for the radio measurements data 116, this information likewise can be provided as either a single-time-point measurements sample, as a time series of measurement samples over a fixed or variable sliding window, or a combination thereof. The radio measurements data 116 reflects measurements of various parameters or metrics of either or both of received RF signaling or transmitted RF signaling. Examples of such radio measurements can include a Reference Signal Received Power (RSRP) measurement, a Reference Signal Received Quality (RSRP) measurement, a Signal-to-Noise Ratio (SNR) measurement, a Signal-to-Noise-plus-Interference Ratio (SNIR), a Signal-to-Interference-plus-Noise Ratio (SINR) measurement, a Received Signal Strength Indicator (RSSI) measurement, a Reference Signal Received Quality (RSRQ) measurement, an Interference over Thermal (IoT) ratio measurement, and the like.

As noted, the output of the RRM NN 112 responsive to input of the local sensor data 114 and the radio measurements data 116 represents one or more RRM actions 118 to be performed by the UE 104. An RRM action 118 can fall into at least one of the following categories: (1) direction to take, or refrain from, an RRM process at the UE 104; (2) direction to modify or set a parameter of an RRM process to be performed at the UE; or (3) determination of a decision for a conditional RRM process for the UE 104. The first category of RRM actions represents an RRM action 118 that the UE 104 responds to by either performing an RRM process or refraining from an RRM process that the UE 104 would otherwise perform. For example, based on local sensor data 114 indicating that the UE 104 is stationary and in a location that is relatively devoid of signal obstructors, the RRM NN 112 may output an RRM action 118 that directs the UE 104 to perform a one-time RRM measurement (e.g., scan of a particular frequency band) and report the results back to the serving BS 110-1. Conversely, based on local sensor data 114 indicating that the UE 104 is in very rapid motion or indicating that the UE 104 is indoors and surrounded by substantial RF-blocking objects, the RRM NN 112 may output an RRM action 118 that directs the UE 104 to skip the next scheduled RRM measurement as a reflection of the potential futility of attempting the scheduled RRM measurement in the UE's current operating environment (and thus potentially conserving power and compute resources of the UE).

The second category of RRM actions represents an RRM action 118 that the UE 104 responds to by modifying an RRM process that the UE 104 is already scheduled or directed to take. For example, the UE 104 may be configured to perform a certain RRM measurement in accordance with a certain timing, and the RRM action 118 can represent a modification to this timing. To illustrate, the 3GPP Fifth Generation New Radio (5G NR) specifications provide for a comparison of the relative signal strength of the serving cell (e.g., as provided by serving BS 110-1) with a neighboring cell (e.g., as provided by target BS 110-2) through a cell signal measurement process using Synchronization Signal (SS)/Physical Broadcast Channel (PBCH) Block, or SSB, where the timing, or periodicity, of each successive measurement using SSB is controlled via an SSB-based RRM Measurement Timing Configuration (SMTC) window. Thus, one or both of the input local sensor data 114 or the present radio measurements data 116 may trigger the trained RRM NN 112 to provide an output representing an RRM action 118 that directs the UE 104 to adjust the SMTC window, thereby increasing or decreasing (depending on the adjustment) the periodicity of SSB-based cell measurements for the serving and neighboring cells.

The third category of RRM actions represents an RRM action 118 that represents a decision made for one or more conditional RRM processes that may be performed by the UE 104. For example, the 3GPP 5G NR Release 16 specification provides for a conditional handover (CHO) RRM process in which a handover command is transmitted to a UE along with one or more conditions to be monitored by the UE in association with the handover command. Rather than implementing the handover immediately, the handover command instead is stored and the UE monitors the specified one or more conditions. When a monitored condition is met, the UE then initiates the previously-received handover. Thus, with regard to this example, the RRM action 118 may mimic the CHO process without requiring the specific handover conditions to be statically or algorithmically defined. Rather, the RRM NN 112 is trained using training data sets with similar training sensor data and similar training radio measurements data to make CHO-like decisions, and thus the RRM action 118 output by the RRM NN 112 out in the field can include a CHO decision to either initiate a handover or to refrain from initiating a handover based on the current network and UE contexts as reflected in the input local sensor data 114 and the radio measurements data 116. Other such conditional RRM processes decisions that may be specified as an RRM action 118 can include, for example, a conditional primary cell change (CPC) in which a change in the primary cell (Pcell) is executed by the UE when one or more specified conditions are met.

An RRM action 118 also may be a combination of two or more of the three categories identified above; that is, an RRM action 118 may be a hybrid RRM action. To illustrate, the output of the RRM NN 112 may represent an RRM action 118 that activates a previously-deactivated RRM measurement process as well as configures one or more parameters for that RRM measurement process (e.g., activating inter-RAT scanning as well as configuring the frequencies to scan).

The RRM NN 112 also may receive other inputs that aid in generating outputs representative of RRM actions 118. For example, the 5G NR specifications provide that certain RRM measurements are specific to a combination of the RRC state (IDLE, INACTIVE, CONNECTED) of the UE and whether the 5G NR RAT of the UE is in stand-alone (SA) mode or non-stand-alone (NSA) mode. For example, if a UE is in an RRC IDLE state and in an SA mode, the UE is permitted to perform cell selection or cell reselection, but if the UE is in NSA mode while in the RRC IDLE state, the 5G NR specifications provide that the UE is intended to forgo cell selection or cell-reselection. Similarly, if the UE is an RRC CONNECTED state the UE can perform random access for the primary cell regardless of whether the 5G NR RAT is in SA or NSA mode, but the 5G NR specifications provide that the UE is intended to perform handover only if in SA mode while in this RRC state. Accordingly, the UE 104 can provide operational state data 120 as an input to the RRM NN 112, with this operational state data 120 representing the particular operational state parameters of the UE 104 and/or the RATs of the UE 104, such as the, for example, the RRC state and SA/NSA mode of the 5G NR RAT of the UE 104. In this example, the RRM NN 112 could be trained using training data to avoid providing outputs that trigger RRM actions 118 that represent RRM processes that would be inconsistent with the RRC state and SA/NSA mode limitations on certain RRM measurements.

In order for the UE 104 to utilize the RRM NN 112 for RRM actions, the UE 104 first is configured with the RRM NN 112. Further, in some embodiments, the underlying architectural configuration of the RRM NN 112 can be updated, either through local updates or via remote updates implemented via reporting of related information by the UE 104. View 121 of FIG. 1 illustrates a general overview of the process of initial configuration and update of the UE 104 in use of the RRM NN 112. In at least one embodiment, the RRM NN 112 employed by the UE 104 has been trained using training data similar to the data input that is expected to be provided by the UE 104. As explained above, the data input to the RRM NN 112 includes local sensor data 114 generated by the particular set of sensors available to the UE 104 as well as radio measurements data 116 representing the particular types of radio measurements that can be made by the UE 104. As such, it is advantageous to select a trained NN architectural configuration for the RRM NN 112 to be employed by the UE 104 that has been trained using training data from similar sensors and for similar radio measurement types. For example, employing a NN architectural configuration for the RRM NN 112 that was trained using training data that is heavily influenced by radar sensor data would typically provide less-effective results at a UE that does not have a radar sensor. To that end, the serving BS 110-1 stores, or otherwise has access to, a set of various NN architectural configurations, each being trained in accordance with a particular sensor configuration and/or radio measurement configuration. During an initialization process between the serving BS 110-1 and the UE 104, the UE 104 provides a representation of its capabilities (UE capabilities message 122) to the serving BS 110-1. The UE capabilities message 122 includes a representation of various capabilities of the UE 104, including one or both of a representation of the sensor capabilities of the UE 104 or a representation of radio measurement capabilities of the UE 104. The representation of the sensor capabilities of the UE 104 can include, for example, a representation of the types of sensors included in the sensor set of the UE 104, the capabilities or other parameters of each of some or all of the sensors, and the like. For example, during the attach process, the serving BS 110-1 may transmit a UE Capabilities Enquiry Radio Resource Control (RRC) message to the UE 104, to which the UE 104 responds with a UECapabilitiesInformation RRC message, with one or more fields of the UECapabilitiesInformation RRC message including data or other information that represents the type, quantity, and parameters of the sensors of the sensor set of the UE 104.

As shown in FIG. 1, the serving BS 110-1 (or another infrastructure component, such as a server of the core network 106) then uses the sensor and/or radio measurement capabilities of the UE 104 as indicated in the UE capabilities message 122 to select an RRM NN architectural configuration 124 for the UE 104 that is appropriate for the indicated sensor capabilities and/or radio measurement capabilities. This selection can be performed using any of a variety of techniques, such as using one or more look-up tables (LUTs) indexed via indicated capability, via a weighted rating comparing indicated capabilities with sensor type/parameters and/or radio measurement types used to train a corresponding candidate RRM NN architectural configuration, and the like. The serving BS 110-1 then signals the UE 104 to employ the selected RRM NN architectural configuration 124. For example, in some embodiments, the serving BS 110-1 may transmit one or more messages to the UE 104 with data representing the actual RRM NN architectural configuration 124. In other embodiments, the UE 104 may already be provisioned with a set of stored RRM NN architectural configurations, and the serving BS 110-1 then may transmit a message that includes an index or other identifier of the particular RRM NN architectural configuration to be utilized by the UE 104 from its stored set.

In response to the identification or provision of the RRM NN architectural configuration 124, the UE 104 configures the RRM NN 112 to utilize the identified RRM NN architectural configuration 124 and begins operation of the RRM NN 112 as so configured. In the course of operation, and consistent with many RRM schemes, the UE 104 may provide various RRM reporting 126 back to the serving BS 110-1. This RRM reporting 126 can include reporting of RRM measurements made by the UE 104, including those directed by, or configured by, the RRM NN 112. The RRM reporting 126 further can include reporting of the decisions or configurations reflected in the RRM actions 118 output by the RRM NN 112. For example, the UE 104 can report, via RRM reporting 126, when it has changed the frequency at which the UE conducts inter-RAT or intra-RAT scanning as a result of an RRM action 118 output by the RRM NN 112. The serving BS 110-1 then can take local action responsive to this RRM reporting 126 or forward the RRM reporting 126 to the core network 106 for further consideration by the network infrastructure 102.

In some embodiments, the RRM NN architectural configuration employed by the RRM NN 112 can be dynamically updated based on use. In some embodiments, an NN update to the RRM NN 112 is provided by the serving BS 110-1 (or other infrastructure component). In this approach, the UE 104 can provide copies 128 of the local sensor data 114 and/or the radio measurements data 116 to the serving BS 110-1, and the serving BS 110-1 or other component can use this data, along with, for example, the RRM reporting 126 to re-train the NN architectural configuration 124 that was utilized by the UE 104 to generate an updated NN architectural configuration and provide this updated NN architectural configuration to the UE 104 for implementation as an NN update 130. In other embodiments, an NN update is performed by the UE 104 itself. For example, the UE 104 may be configured to provide a copy, or “snapshot”, of the current state of the NN architectural configuration of the RRM NN 112 as an NN update 130 to the serving BS 110-1 on a periodic basis. The serving BS 110-1 then can update its local or accessible copy of the RRM NN architectural configuration 124 to reflect the supplied NN update 130, and further may redistribute this updated NN architectural configuration to other UEs that are employing the same NN architectural configuration 124.

FIG. 2 illustrates example hardware configurations for the UE 104 (as representative wireless) in accordance with some embodiments. Note that the depicted hardware configuration represents the processing components and communication components most directly related to the neural network-based processes described herein and omits certain components well-understood to be frequently implemented in such electronic devices, such as displays, non-sensor peripherals, external power supplies, and the like.

In the depicted configuration, the UE 104 includes an RF front end 202 having one or more antennas 203 and a radio interface 204 having one or more modems to support one or more RATs. The RF front end 202 operates, in effect, as a physical (PHY) transceiver interface to conduct and process signaling between one or more processors 206 of the UE 104 and the antennas 203 to facilitate various types of wireless communication. The antennas 203 can be arranged in one or more arrays of multiple antennas that are configured similar to or different from each other and can be tuned to one or more frequency bands associated with a corresponding RAT. The one or more processors 206 can include, for example, one or more central processing units (CPUs), graphics processing units (GPUs), tensor processing units (TPUs) or other application-specific integrated circuits (ASIC), and the like. To illustrate, the processors 206 can include an application processor (AP) utilized by the UE 104 to execute an operating system and various user-level software applications, as well as one or more processors utilized by modems or a baseband processor of the radio interface 204.

The UE 104 further includes one or more computer-readable media 208 that include any of a variety of media used by electronic devices to store data and/or executable instructions, such as random-access memory (RAM), read-only memory (ROM), caches, Flash memory, solid-state drive (SSD) or other mass-storage devices, and the like. For ease of illustration and brevity, the computer-readable media 208 is referred to herein as “memory 208” in view of the frequent use of system memory or other memory to store data and instructions for execution by the processor 206, but it will be understood that reference to “memory 208” shall apply equally to other types of storage media unless otherwise noted.

In at least one embodiment, the UE 104 further includes a plurality of sensors distinct from the radio interface 204 and referred to collectively herein as sensor set 210, at least some of which are utilized in the neural-network-based schemes described herein. Generally, the sensors of the sensor set 210 include those sensors that sense some aspect of the external RF environment of the UE 104 (that is, sensors that have the potential to sense a parameter that has at least some impact on, or is a reflection of, an RF propagation path of, or RF transmission/reception performance by, the UE 104), sensors that sense some aspect of a present operating status of the UE 104, such as battery status, thermal status, operating mode, screen state, and the like. As such, the sensors of the sensor set 210 can include one or more sensors 212 for object detection, such as radar sensors, lidar sensors, imaging sensors, structured-light-based depth sensors, proximity sensors, and the like. The sensor set 210 also can include one or more sensors 214 for determining a position, pose, or velocity/speed of the UE 104, such as satellite positioning sensors such as GPS sensors, Global Navigation Satellite System (GNSS) sensors, internal measurement unit (IMU) sensors, visual odometry sensors, accelerometers, gyroscopes, barometers, altimeters, tilt sensors or other inclinometers, ultrawideband (UWB)-based sensors, and the like. Other examples of types of sensors of the sensor set 210 can include sensors 216 for determining a present operating status of the UE 104, such as battery level sensors, thermal sensors, screen mode sensors, and the like. Although not illustrated, it will be appreciated that the UE 104 further can include one or more batteries or other portable power sources, one or more user interface (UI) components, such as touch screens, user-manipulable input/output devices (e.g., “buttons” or keyboards), or other touch/contact sensors, microphones, or other voice sensors for capturing audio content, and the like.

The one or more memories 208 of the UE 104 are used to store one or more sets of executable software instructions and associated data that manipulate the one or more processors 206 and other components of the UE 104 to perform the various functions described herein and attributed to the UE 104. The sets of executable software instructions include, for example, an operating system (OS) and various drivers (not shown), and various software applications. The sets of executable software instructions further include one or more of a neural network management module 218, a capabilities management module 220, or an RRM module 222. The neural network management module 218 implements one or more neural networks for the UE 104, as described in detail below. The capabilities management module 220 determines various capabilities of the UE 104 that may pertain to neural network configuration or selection and reports such capabilities to the serving BS 110-1 (e.g., in one or more UECapabilitiesInformation RRC messages), as well as monitors the UE 104 for changes in such capabilities, including changes in RF and processing capabilities, changes in accessory availability or capability, and the like, and manages the reporting of such capabilities, and changes in the capabilities, to the serving BS 110-1. The RRM module 222 operates to perform RRM processes at the UE 104, including RRM measurement and reporting as well as the RRM action(s) 118 specified by the output of the RRM NN 112.

To facilitate the operations of the UE 104 as described herein, the one or more memories 208 of the UE 104 further can store data associated with these operations. This data can include, for example, one or more neural network architectural configurations 224 (an embodiment of the RRM NN architectural configuration 124, FIG. 1), as well as device data 226. The device data 226 represents, for example, user data, multimedia data, beamforming codebooks, software application configuration information, and the like. The device data 226 further can include capability information for the UE 104, such as sensor capability information regarding the one or more sensors of the sensor set 210, including the presence or absence of a particular sensor or sensor type, and, for those sensors present, one or more representations of their corresponding types and capabilities, such as range and resolution for lidar or radar sensors, image resolution and color depth for imaging cameras, and the like. The capability information further can include information regarding, for example, the capabilities or status of a battery, the capabilities or status of the radio interface 204 and antenna(s) 203 (e.g., frequency capabilities, radio measurement capabilities, etc.), and the like.

Each neural network architectural configuration 224 includes one or more data structures containing data and other information representative of a corresponding architecture and/or parameter configurations used by the neural network management module 218 to form a corresponding RRM neural network 112 of the UE 104. The information included in a neural network architectural configuration 224 includes, for example, parameters that specify a fully connected layer neural network architecture, a convolutional layer neural network architecture, a recurrent neural network layer, a number of connected hidden neural network layers, an input layer architecture, an output layer architecture, a number of nodes utilized by the neural network, coefficients (e.g., weights and biases) utilized by the neural network, kernel parameters, a number of filters utilized by the neural network, strides/pooling configurations utilized by the neural network, an activation function of each neural network layer, interconnections between neural network layers, neural network layers to skip, and so forth. Accordingly, the neural network architectural configuration 224 includes any combination of neural network formation configuration elements (e.g., architecture and/or parameter configurations) that can be used to create a neural network architectural configuration (e.g., a combination of one or more neural network formation configuration elements) that defines and/or forms a DNN or other neural network.

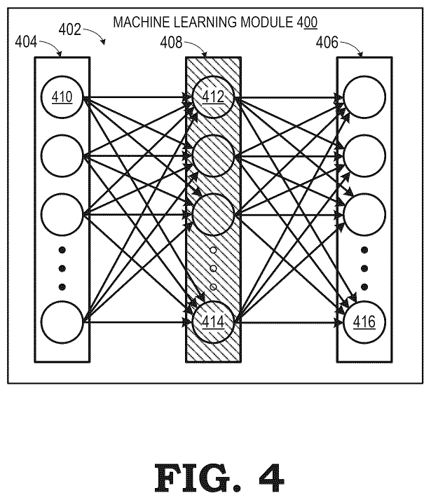

FIG. 3 illustrates example hardware configurations for a BS 110 (as representative infrastructure component) in accordance with some embodiments. Note that the depicted hardware configuration represents the processing components and communication components most directly related to the neural network-based processes described herein and omits certain components well-understood to be frequently implemented in such electronic devices, such as displays, non-sensor peripherals, external power supplies, and the like. Further note that although the illustrated diagram represents an implementation of the BS 110 as a single network node (e.g., a 5G NR Node B, or “gNB”), the functionality, and thus the hardware components, of the BS 110 instead may be distributed across multiple network nodes or devices and may be distributed in a manner to perform the functions described herein.

In the depicted configuration, the BS 110 includes an RF front end 302

having one or more antennas 303 and a radio interface 304 having one or more modems to support one or more RATs, and which operates as a PHY transceiver interface to conduct and process signaling between one or more processors 306 of the BS 110 and the antennas 303 to facilitate various types of wireless communication. The antennas 303 can be arranged in one or more arrays of multiple antennas that are configured similar to or different from each other and can be tuned to one or more frequency bands associated with a corresponding RAT. The one or more processors 306 can include, for example, one or more CPUs, GPUs, TPUs or other ASICs, and the like. The BS 110 further includes one or more computer- readable media 308 that include any of a variety of media used by electronic devices to store data and/or executable instructions, such as RAM, ROM, caches, Flash memory, SSD or other mass-storage devices, and the like. As with the memory 208 of the UE 104, for ease of illustration and brevity, the computer-readable media 308 is referred to herein as “memory 308” in view of the frequent use of system memory or other memory to store data and instructions for execution by the processor 306, but it will be understood that reference to “memory 308” shall apply equally to other types of storage media unless otherwise noted.

The one or more memories 308 of the BS 110 are used to store one or more sets of executable software instructions and associated data that manipulate the one or more processors 306 and other components of the BS 110 to perform the various functions described herein and attributed to the BS 110. The sets of executable software instructions include, for example, an OS and various drivers (not shown), and various software applications. The sets of executable software instructions further include one or more of a neural network management module 310, a training module 312, and an RRM module 314. The one or more memories 308 further store various information, such as a set 322 of one or more candidate neural network architectural configurations 324 (embodiments of the RRM NN architectural configuration 124, FIG. 1), as well as various BS data 326. The BS data 326 represents, for example, beamforming codebooks, software application configuration information, RRM scheme information, and the like. The neural network architectural configurations 324 represent trained neural network architectural configurations that can be employed at an RRM NN 112 of the UE 014 or other UE. Thus, as with the neural network architectural configurations 224 of FIG. 2, each candidate neural network architectural configuration 324 includes one or more data structures containing data and other information representative of a corresponding architecture and/or parameter configurations used by a neural network management module 218 of a UE, such as UE 104, to form a corresponding RRM NN 112 at the UE. The neural network management module 310 manages the training, re-training, selection, and delivery of the neural network architectural configurations 324 to the UE 104 and other UEs. The training module 312 performs the actual training/retraining of a selected neural network architectural configuration 324 using sensor data, radio measurements data, and other feedback from one or more Ues. The RRM module 314 operates to perform various RRM processes to be performed by the BS 110.

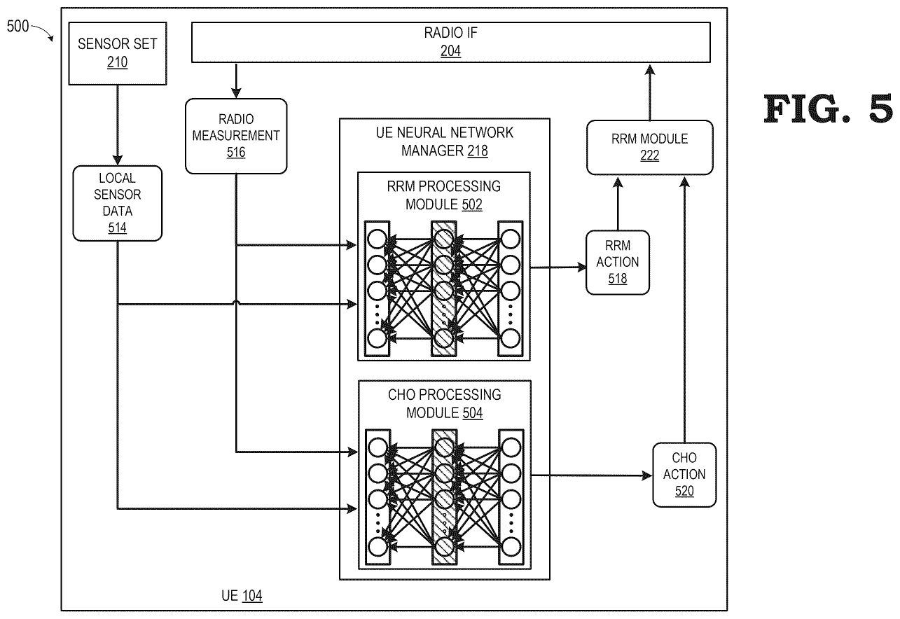

FIG. 4 illustrates an example machine learning (ML) module 400 for implementing a neural network in accordance with some embodiments. As described herein, the UE 104 implements one or more DNNs or other neural networks as an RRM NN 112 for configuring or control of RRM processes at the UE 104. Relatedly, the BS 110 trains, re-trains, or otherwise updates copies of the one or more DNNs or other neural networks used as RRM NNs 112 at one or more Ues. The ML module 400 therefore illustrates an example module for implementing one or more of these neural networks.

In the depicted example, the ML module 400 implements at least one deep neural network (DNN) 402 with groups of connected nodes (e.g., neurons and/or perceptrons) that are organized into three or more layers. The nodes between layers are configurable in a variety of ways, such as a partially connected configuration where a first subset of nodes in a first layer are connected with a second subset of nodes in a second layer, a fully-connected configuration where each node in a first layer is connected to each node in a second layer, etc. A neuron processes input data to produce a continuous output value, such as any real number between 0 and 1. In some cases, the output value indicates how close the input data is to a desired category. A perceptron performs linear classifications on the input data, such as a binary classification. The nodes, whether neurons or perceptrons, can use a variety of algorithms to generate output information based upon adaptive learning. Using the DNN 402, the ML module 400 performs a variety of different types of analysis, including single linear regression, multiple linear regression, logistic regression, stepwise regression, binary classification, multiclass classification, multivariate adaptive regression splines, locally estimated scatterplot smoothing, and so forth.

In some implementations, the ML module 400 adaptively learns based on supervised learning. In supervised learning, the ML module 400 receives various types of input data as training data. The ML module 400 processes the training data to learn how to map the input to a desired output. As one example, the ML module 400 receives sequences of training data in the form of training sensor data and training radio measurement data and learns how to, in effect, map the input training data to desired outputs, namely, RRM actions. In particular, during a training procedure, the ML module 400 uses labeled or known data as an input to the DNN 402. The DNN 402 analyzes the input using the nodes and generates a corresponding output. The ML module 400 compares the corresponding output to truth data and adapts the algorithms implemented by the nodes to improve the accuracy of the output data. Afterward, the DNN 402 applies the adapted algorithms to unlabeled input data to generate corresponding output data. The ML module 400 uses one or both of statistical analysis and adaptive learning to map an input to an output. For instance, the ML module 400 uses characteristics learned from training data to correlate an unknown input to an output that is statistically likely within a threshold range or value. This allows the ML module 400 to receive complex input and identify a corresponding output. As noted, some implementations train the ML module 400 on characteristics of RRM decisioning based on input sensor data and radio measurements data. This allows the trained ML module 400 to receive a set of sensor data (either as sensor data from a single time slice or over a sequence of time slices) and a set of radio measurements data (either from a single time slice or over a sequence of time slices), and from these inputs generate an output representative of RRM action(s) to be performed.

In the depicted example, the DNN 402 includes an input layer 404, an output layer 406, and one or more hidden layers 408 positioned between the input layer 404 and the output layer 406. Each layer has an arbitrary number of nodes, where the number of nodes between layers can be the same or different. That is, the input layer 404 can have the same number and/or a different number of nodes as output layer 406, the output layer 406 can have the same number and/or a different number of nodes than the one or more hidden layer 408, and so forth.

Node 410 corresponds to one of several nodes included in input layer 404, wherein the nodes perform separate, independent computations. As further described, a node receives input data and processes the input data using one or more algorithms to produce output data. Typically, the algorithms include weights and/or coefficients that change based on adaptive learning. Thus, the weights and/or coefficients reflect information learned by the neural network. Each node can, in some cases, determine whether to pass the processed input data to one or more next nodes. To illustrate, after processing input data, node 410 can determine whether to pass the processed input data to one or both of node 412 and node 414 of hidden layer 408. Alternatively or additionally, node 410 passes the processed input data to nodes based upon a layer connection architecture. This process can repeat throughout multiple layers until the DNN 402 generates an output using the nodes (e.g., node 416) of output layer 406.

A neural network can also employ a variety of architectures that determine what nodes within the neural network are connected, how data is advanced and/or retained in the neural network, what weights and coefficients are used to process the input data, how the data is processed, and so forth. These various factors collectively describe a neural network architectural configuration, such as the neural network architectural configurations briefly described above. To illustrate, a recurrent neural network, such as a long short-term memory (LSTM) neural network, forms cycles between node connections to retain information from a previous portion of an input data sequence. The recurrent neural network then uses the retained information for a subsequent portion of the input data sequence. As another example, a feed-forward neural network passes information to forward connections without forming cycles to retain information. While described in the context of node connections, it is to be appreciated that a neural network architectural configuration can include a variety of parameter configurations that influence how the DNN 402 or other neural network processes input data.

A neural network architectural configuration of a neural network can be characterized by various architecture and/or parameter configurations. To illustrate, consider an example in which the DNN 402 implements a convolutional neural network (CNN). Generally, a convolutional neural network corresponds to a type of DNN in which the layers process data using convolutional operations to filter the input data. Accordingly, the CNN architectural configuration can be characterized by, for example, pooling parameter(s), kernel parameter(s), weights, and/or layer parameter(s).

A pooling parameter corresponds to a parameter that specifies pooling layers within the convolutional neural network that reduce the dimensions of the input data. To illustrate, a pooling layer can combine the output of nodes at a first layer into a node input at a second layer. Alternatively or additionally, the pooling parameter specifies how and where in the layers of data processing the neural network pools data. A pooling parameter that indicates “max pooling,” for instance, configures the neural network to pool by selecting a maximum value from the grouping of data generated by the nodes of a first layer, and uses the maximum value as the input into the single node of a second layer. A pooling parameter that indicates “average pooling” configures the neural network to generate an average value from the grouping of data generated by the nodes of the first layer and uses the average value as the input to the single node of the second layer.

A kernel parameter indicates a filter size (e.g., a width and a height) to use in processing input data. Alternatively or additionally, the kernel parameter specifies a type of kernel method used in filtering and processing the input data. A support vector machine, for instance, corresponds to a kernel method that uses regression analysis to identify and/or classify data. Other types of kernel methods include Gaussian processes, canonical correlation analysis, spectral clustering methods, and so forth. Accordingly, the kernel parameter can indicate a filter size and/or a type of kernel method to apply in the neural network. Weight parameters specify weights and biases used by the algorithms within the nodes to classify input data. In some implementations, the weights and biases are learned parameter configurations, such as parameter configurations generated from training data. A layer parameter specifies layer connections and/or layer types, such as a fully-connected layer type that indicates to connect every node in a first layer (e.g., output layer 406) to every node in a second layer (e.g., hidden layer 408), a partially-connected layer type that indicates which nodes in the first layer to disconnect from the second layer, an activation layer type that indicates which filters and/or layers to activate within the neural network, and so forth. Alternatively or additionally, the layer parameter specifies types of node layers, such as a normalization layer type, a convolutional layer type, a pooling layer type, and the like.

While described in the context of pooling parameters, kernel parameters, weight parameters, and layer parameters, it will be appreciated that other parameter configurations can be used to form a DNN consistent with the guidelines provided herein. Accordingly, a neural network architectural configuration can include any suitable type of configuration parameter that can be applied to a DNN that influences how the DNN processes input data to generate output data.

In some embodiments, the configuration of the ML module 400 is further based on the sensor capabilities and/or radio measurement capabilities of a UE that is to implement the ML module 400. As such, the architectural configuration of the ML module 400 also may be based on capabilities of the UE implementing the ML module 400. For example, the UE 104 may have considerable imaging capabilities, and thus the ML module 400 for the UE 104 may be trained based image data as an input so as to facilitate, for example, the ML module 400 to generate RRM actions that are well suited for RF transmission environments that are dependent on the presence or absence of objects or other interferers that would be represented in such image data. However, for a UE that has no imaging capabilities, using an ML module 400 configured via training extensively based on training image data would generally be less well suited for generating effective RRM actions based on input sensor data that is absent of imaging data. Accordingly, in some embodiments, the device implementing the ML module 400 may be configured to implement different neural network architectural configurations for different combinations of sensor capabilities, radio measurement capabilities, or both. For example, a device may have access to one or more neural network architectural configurations for use when a radar sensor is available for use at the device and a different set of one or more neural network architectural configurations for use when radar sensor is unavailable but a radar sensor is available.

In some embodiments, the UE 104 implementing the ML module 400 locally stores some or all of a set of candidate neural network architectural configurations that can be employed for the ML module 400. For example, candidate neural network architectural configurations 224 may be indexed at the UE 104 by a look-up table (LUT) or other data structure that takes as inputs one or more parameters, such as one or more sensor capability parameters or radio measurement capabilities, and outputs an identifier associated with a corresponding locally-stored candidate neural network architectural configuration that is suited for operation in view of the input parameter(s). In other embodiments, the UE 104 provides a representation of its capabilities and the BS 110 or other infrastructure component selects a neural network architectural configuration for implementation at the UE 104 based on these capabilities. To facilitate the process of selecting an appropriate neural network architectural configuration, in at least one embodiment the BS 110 or other infrastructure component trains different versions of the ML module 400 using the neural network management module 310 and training module 312. For example, the training module 312 can mathematically generate training data, access files that store the training data, obtain real-world communications data, etc. The neural network management module 310 then extracts and stores the various learned neural network architectural configurations for subsequent use. Some implementations store input characteristics with each neural network architectural configuration, whereby the input characteristics describe various sensor characteristics and/or radio measurement characteristics.

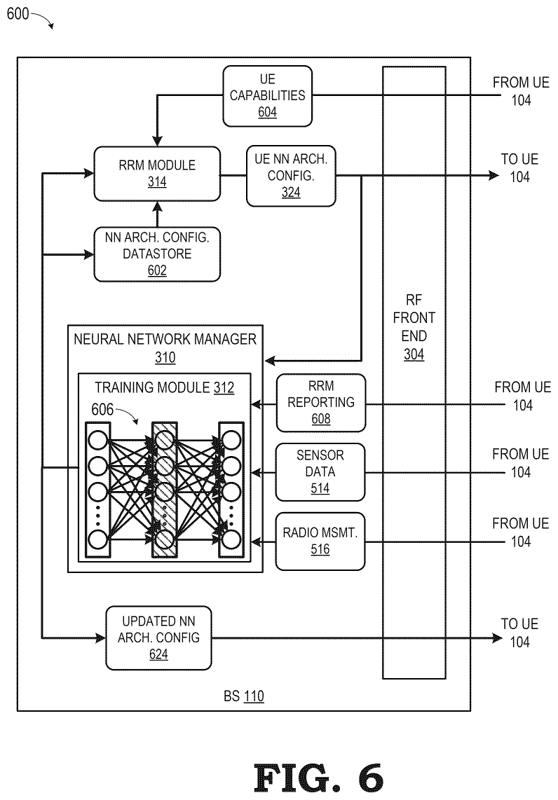

As noted, a wireless device, such as the UE 104, can be configured to determine one or more RRM actions using one or more RRM DNNs, where each RRM DNN supplements or replaces one or more functions conventionally implemented by one or more hard-coded or fixed-design blocks. Moreover, each DNN can further incorporate current sensor data from one or more sensors of a sensor set of the wireless device, in effect, modify or otherwise adapt its operation to account for the current RF signal propagation environment or operating state of the wireless device reflected in the sensor data. To this end, FIG. 5 illustrates an example operating environment 500 for DNN implementation at the UE 104. In the depicted example, the neural network management module 218 of the UE 104 implements an RRM processing module 502 for general RRM decision-making process. Moreover, to illustrate a particular use case for neural-network-based RRM management at a UE, the example implementation of the neural network management module 218 is depicted as additionally implementing a CHO processing module 504, which is a particular example implementation of an RRM processing module for the specific purpose of conditional RRM decision-making, which in this case is CHO decision-making. Thus, the CHO processing module 504 may be understood to be a separate RRM processing module specifically implemented for CHO decision-making, or alternatively as that portion of the RRM processing module 502 that results in RRM actions that impact CHO decision-making.

As a general operational overview of the UE 104 with respect to the depicted operating environment 500 in FIG. 5, the neural network management module 218 is supplied with neural network architectural configurations 224 (FIG. 2) for each of the RRM processing module 502 and the CHO processing module 504 based on the sensor capabilities of the sensors of the sensor set 210 and/or the radio measurement capabilities of the radio interface 204. In accordance with respective schedules, the sensor set 210 provides a recent local sensor data set 514 (one embodiment of local sensor data 114, FIG. 1) obtained from one or more sensors of the sensor set 210 and the radio interface 204 provides a recent radio measurements data set 516 (one embodiment of radio measurements data 116, FIG. 1) to the neural network management module 218, which in turn provides these data sets as inputs to each of the RRM processing module 502 and the CHO processing module 504. Other inputs, such as the present RRC state (IDLE, INACTIVE, CONNECTED) or the RAT mode (e.g., standalone (SA) or non-stand-alone (NSA) for 5G NR RATs), also may be provided to the processing modules 502 and 504.

The RRM processing module 502 utilizes these inputs to generate at least one RRM action 518 (one embodiment of RRM action 118), which is provided to the RRM module 222 for implementation. As explained above, the RRM action 518 can represent an RRM process to be performed, such as taking an RRM measurement and reporting it to the serving BS 110-1, an RRM process to be skipped, such as skipping a scheduled cell re-selection process, a modification to be made to one or more RRM processes, such as reconfiguring an intra-RAT measurement periodicity, or a combination thereof. As such, the RRM module 222 controls one or more parameters and other controls of the radio IF 204 to enact the RRM action 518. For example, the periodicity of an inter-RAT scan may be implemented as a value stored in a register of the radio IF 204, and the RRM module 222 can implement an RRM action 518 that seeks to change this periodicity by overwriting the register with a new value. As another example, the radio interface 204 may provide an application programming interface (API) or other interface, and the RRM module 222 can trigger the radio interface 204 to perform an RRM measurement represented by the RRM action 518 by triggering the RRM measurement via the API or other interface.

Concurrently (or as part of the RRM processing module 502), the CHO processing module 504 utilizes the inputs to generate an output representative of a CHO action 520, which is likewise provided to the RRM module 222 for implementation. The CHO action 520 can include for example, a CHO decision, such as a decision to initiate a handover based on the handover conditions as interpreted through the local sensor data set 514 and the radio measurements data set 516 or a decision to forego initiation of a handover based on the handover conditions as interpreted through these inputs. Additionally or alternatively, the CHO action 520 can include a modification to a static CHO configuration. For example, the BS 110 may have messaged the UE 104 to implement a CHO in which a handover is initiated when a set of specified monitored conditions are met, and the CHO action 520 can include a modification of the thresholds or other triggers represented in this set of monitored conditions. For example, the BS 110 may specify that a handover it to be initiated when a measured RSRP falls below a specified threshold. However, the CHO processing module 504 may have been trained using training data that reflects a situation in which a UE has a low measured RSRP but has a high velocity, the measured RSRP may change quickly as the UE's position relative to the serving cell is changing quickly. As such, the result of training may configure the CHO processing module 504 to act to modify the threshold for RSRP before a handover is triggered when the input local sensor data set 514 includes sensor data indicating the UE 104 is moving rapidly and the radio measurements data set 516 indicates that the measured RSRP is bouncing near the original specified threshold. In either approach, the RRM module 222 receives the CHO action 520 and coordinates with the radio interface 204 to enact the process represented by the CHO action 520, such as initiating a handover, foregoing initiation of a handover, or modifying one or more monitored parameters of the conditions the radio interface 204 is to monitor for purposes of deciding whether to initiate a handover.

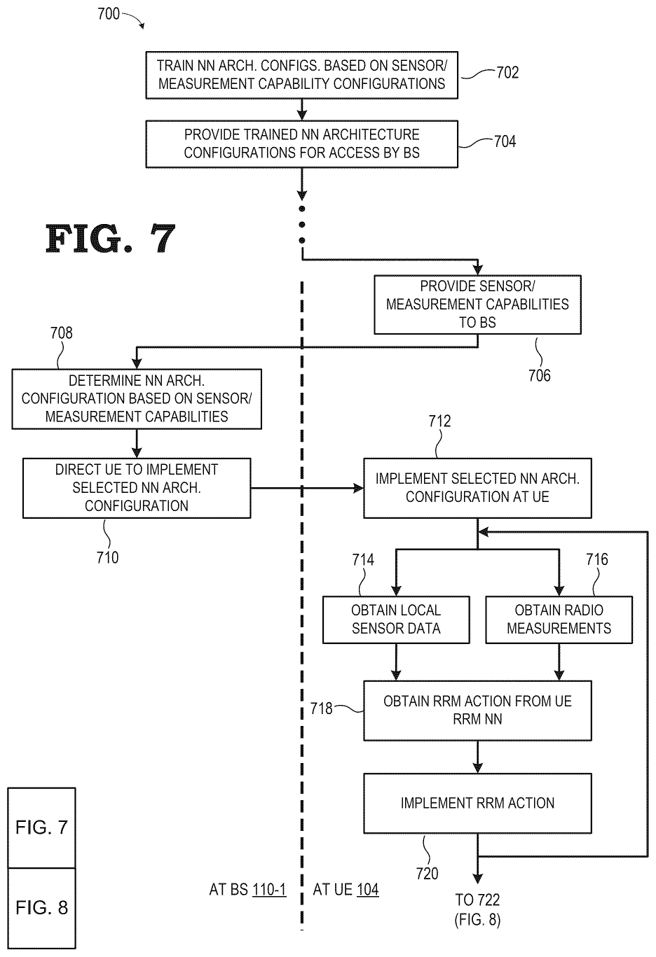

FIG. 6 illustrates an example operating environment 600 of a BS 110 (e.g., the serving BS 110-1) for supporting a neural-network-based RRM at the UE 104 in accordance with at least one embodiment. As described above, for the neural-network-based RRM process the BS 110, in some embodiments, operates to provide the UE 104 with a neural network architectural configuration that is suited for the particular sensor capabilities and/or radio measurement capabilities of the UE 104 as well, to train/retrain the neural network architectural configuration, or a combination of both. For the selection and provision of an initial DNN architectural configuration to the UE 104, the BS 110 either implements a neural network architectural configuration datastore 602 or has networked access to the datastore 602 via a server or other infrastructure component of the network infrastructure 102 (FIG. 1). The datastore 602 stores one or more candidate neural network architectural configurations 324 (FIG. 3) that may be indexed or otherwise accessed based on corresponding sensor capability attributes, radio measurement attributes, and the like. Accordingly, when the UE 104 supplies the BS 110 with UE capabilities information 604 that indicates one or both of its sensor capabilities or its radio measurement capabilities, the RF front end 302 of the BS 110 passes the UE capabilities information 604 to the RRM module 314, which utilizes the UE capabilities information 604 to select, from the datastore 602, a neural network architectural configuration 324 that has been trained using training data with the same or similar sensor capabilities and/or the same or similar radio measurement capabilities. This selected neural network architectural configuration 324, or an identifier or other representation thereof, is then transmitted to the UE 104 for implementation.

Moreover, in response to providing the neural network architectural configuration 324 to the UE 104, in some embodiments the neural network management module 310 of the BS 110 can direct the training module 312 to instantiate a training processing module 606 that implements a DNN or other neural network that is initially configured with the selected neural network architectural configuration 324 that was supplied to the UE 104. That is, the training processing module 606 is, in effect, a copy of the RRM NN 112 that is operating concurrently at the BS 110. Thereafter, the UE 104 provides feedback in the form of copies of the local sensor data set 514 input to the RRM NN 112, copies of the radio measurements data set 516 input to the RRM NN 112, and/or RRM reporting 608 from the UE 104 provided in response to the UE 104 performing various RRM processes as a result of the RRM actions 118 generated by the RRM NN 112 as a result of receiving the local sensor data set 514 and radio measurements data set 516 as input. This feedback from the UE 104 thus represents the inputs provided to the RRM NN 112. Accordingly, the training module 312 can use this feedback as input to the training processing module 606 to re-train, or update, the DNN or other neural network implemented therein. On a periodic basis or in response to some other trigger event, a modified neural network architectural configuration 624 of the training processing module 606 is extracted and provided to the RRM module 314, which may then store a representation of the modified neural network architectural configuration 624 in the datastore 602 and/or transmit a representation of the modified neural network architectural configuration 624 to the UE 104 for use by the UE 104 in updating the RRM NN 112.

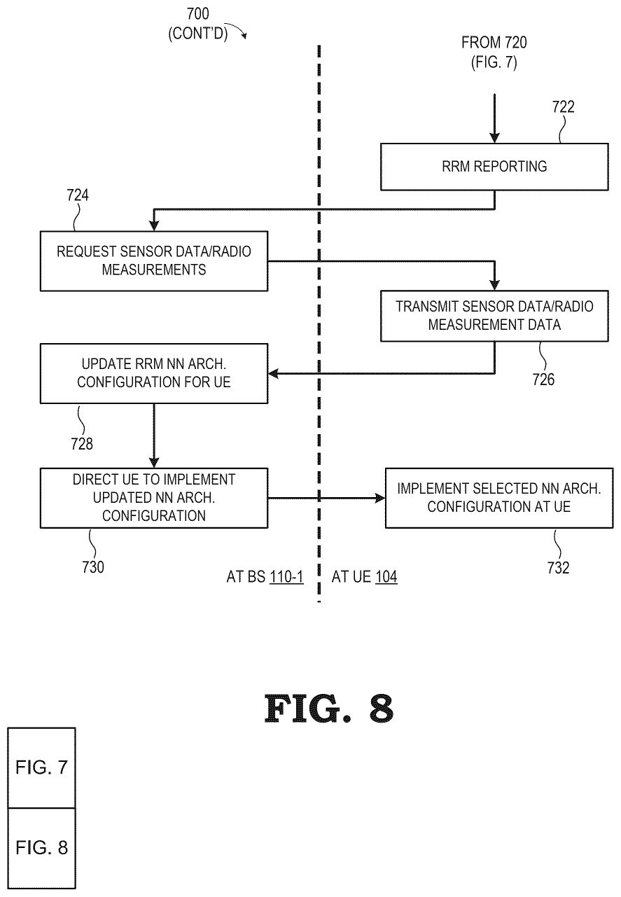

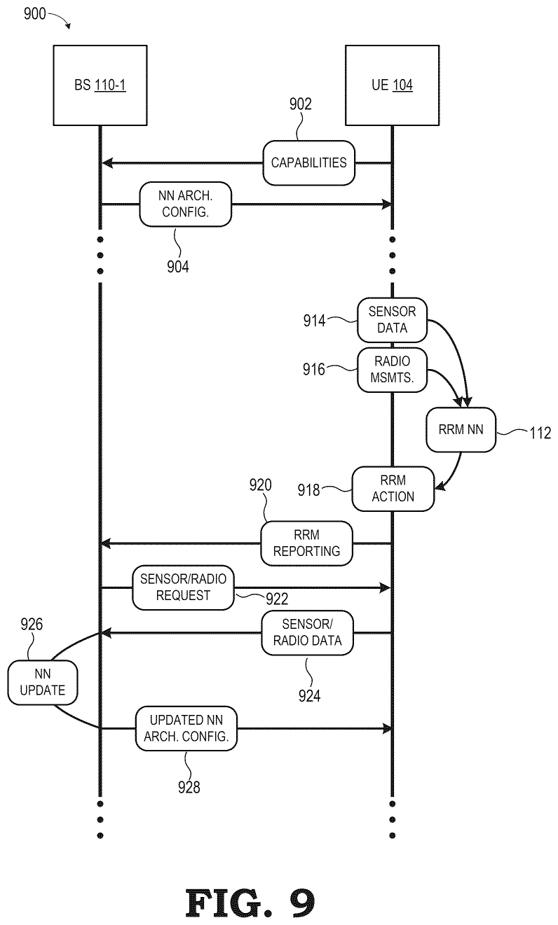

Turning now to FIGS. 7 and 8, a method 700 for implementing an RRM scheme in the wireless communications network 100 that utilizes a neural-network-based RRM process at the UE 104 is described in accordance with at least one embodiment. Note that the order of operations described with reference to method 700 is for illustrative purposes only, and that a different order of operations may be performed, and further that one or more operations may be omitted or one or more additional operations included in the illustrated method. To facilitate understanding, the method 700 is described with reference to an example implementation of the method 700 reflected in a ladder diagram 900 of FIG. 9.

In implementation, the UE 104 may have any of a variety of combinations of sensor capabilities and radio measurement capabilities. For example, sometimes a UE light sensor will be on while at other times the UE will turn off its light sensor to conserve power. As another example, some Ues 104 may have satellite-based positioning sensors, whereas other Ues 104 may not. As yet another example, one UE 104 may have radar or lidar capabilities but no camera capabilities, whereas another UE 104 may have camera capabilities but no radar or lidar capabilities. Because the RRM neural network(s) implemented at the UE 104 utilize sensor data and/or radio measurements as inputs to dictate their operations, it will be appreciated that in many instances the particular neural network architectural configuration implemented at the UE 104 is based on the particular sensors available to provide sensor data as input and/or based on the particular radio measurements the UE is capable of taking; that is, the particular neural network architectural configuration implemented at the RRM NN 112 is reflective of one or both of the type and combination of sensors presently providing input to the RRM NN 112 and the type and parameters of the radio measurements presently provided as input to the RRM NN 112.

Accordingly, the method 700 initiates at block 702 with the determination of the sensor and radio measurement capabilities of one or more test Ues, which may include the UE 104 or may utilize Ues other than the UE 104. It will be appreciated that the “test Ues” in this sense may not actually be physical Ues, but instead software simulations of operations of test Ues for purposes of neural network training. As such, reference to “test UE” shall be understood to also include reference to such simulations. For the training process, a training module (such as the training module 312 of the BS 110 or a similar training module of a server or other infrastructure component) selects a particular sensor configuration and/or radio measurement configuration for which to train a candidate neural network architecture for the RRM NN 112 of the test UE. In some embodiments, the training module may attempt to train every permutation of the available sensors and every permutation of the available radio measurement capabilities. However, in implementations in which non-test Ues have a relatively substantial number and variety of suitable sensors or radio measurement capabilities, this effort may be impracticable. Accordingly, in other embodiments the training module selects from only a limited, representative set of potential sensors and sensor configurations and radio measurement capabilities. To illustrate, lidar information from different lidar modules manufactured by the same company may be relatively consistent, and thus if, for example, the UE 104 could implement any of a number of lidar sensors from that manufacturer, the training module may choose to eliminate several lidar sensors from the sensor configurations being trained. As another example, while a very small subset of Ues 104 may have the capacity to measure SINR at a broader range or at a greater resolution, the training module may restrict the training to a smaller SINR range or a lower SINR resolution that still covers the majority of implementations of the UE 104. In still other embodiments, there may be a defined set of sensor configurations the training module can select for training, and the training module thus selects a sensor configuration from this defined set (and avoid selection of a sensor configuration that relies on a sensor capability that is not commonly supported by the associated device).

With a sensor/radio measurement configuration selected, the training module identifies one or more sets of training data for use in training a candidate neural network architectural configuration based on the selected configuration. That is, the one or more sets of training data include or represent sensor data that could be generated by the comparable sensors of the selected sensor configuration and represent radio measurements data that could be generated consistent with the selected radio measurement capacities, and thus suitable for training the candidate neural network architectural configuration to operate with sensor data provided by the particular sensors represented in the selected sensor/radio measurement configuration. The training data further can include, for example, training data pertaining to operational states of the test UE, such as RRC state or 5G NR SA or NSA modes. With one or more training sets obtained, the training module initiates the training of an RRM NN at the test UE. This training typically involves initializing the bias weights and coefficients of the various RRM NN with initial values, which generally are selected pseudo-randomly, then inputting a set of training data (representing, for example, known sensor data from sensors in the selected sensor configuration and known radio measurement data consistent with the selected radio measurements capabilities configuration), processing the inputs at the test RRM NN to generate an output, determining an error between the actual output and the expected output, and backpropagating the error throughout the test RRM NN, and repeating the process for the next set of input data. This process repeats until a certain number of training iterations have been performed or until a certain minimum error rate has been achieved. As a result of the training of the RRM NN of the test UE, the resulting neural network has a particular neural network architectural configuration, or DNN architectural configuration in instances in which the implemented neural networks are DNNs, that characterizes the architecture and parameters of corresponding RRM NN, such as the number of hidden layers, the number of nodes at each layer, connections between each layer, the weights, coefficients, and other bias values implemented at each node, and the like. Accordingly, when the training of a RRM NN of the test UE for the selected sensor/radio measurements configuration is complete, the present neural network architectural configuration of the trained RRM NN is extracted and, at block 704, made available to one or more BS 110, as a corresponding candidate neural network architectural configuration 324 (FIG. 3) by storing a local copy of the candidate neural network architectural configuration 324 at the BS 110 or by storing a copy of the candidate neural network architectural configuration 324 in a remote datastore accessible by the BS 110. In at least one embodiment, the candidate neural network architectural configuration 324 can be generated by extracting the architecture and parameters of the corresponding RRM NN, such as the number of hidden layers, number of nodes, connections, coefficients, weights, and other bias values, and the like, at the conclusion of the training.

In the event that there are one or more other sensor/radio measurement configurations remaining to be trained, the training process repeats with the selection of the next sensor/radio measurement configuration to be trained. Otherwise, if candidate RRM NNs the UE 104 have been trained for all intended sensor/radio measurement configurations, the network 100 can shift to supporting neural-network-based RRM processes at the UE 104 using the trained DNNs.

Accordingly, as part of, or following, initialization of a wireless connection between the UE 104 and the serving BS 110-1, at block 706 the UE 104 informs the serving BS 110-1 of its sensor capabilities and/or radio measurement capabilities by transmitting a sensor/measurement capabilities message 902 (FIG. 9) to the serving BS 110-1. For example, during an attach procedure the serving BS 110-1 may transmit a UECapabilitiesEnquiry RRC message to the UE 104, and in response, the UE 104 transmits a UECapabilitiesInformation RRC message to the serving BS 110-1, with one or more fields of the UECapabilitiesInformation RRC message (one embodiment of the sensor/measurement capabilities message 902) containing data representative of one or both of the sensor capabilities or the radio measurement capabilities of the UE 104.

At block 708, the neural network management module 310 of the serving BS 110-1 selects a candidate neural network architectural configuration 324 from the set 322 for implementation at the RRM NN 112 of the UE 104 based on one or both of the sensor capabilities advertised by the UE 104 or the radio measurement capabilities advertised by the UE 104. For example, if the UE 104 has a radar sensor and imaging camera available for use and is capable of taking RSRP measurements with a particular range and resolution, the neural network management module 310 may select a candidate neural network architectural configuration 324 for the UE 104 that have been trained for this particular sensor configuration and radio measurement capability. With a suitable neural network architectural configuration selected, at block 710 the serving BS 110-1 directs the UE 104 to implement the selected neural network architectural configuration at the RRM NN 112 by sending a NN configuration message 904 to the UE 104. The NN configuration message 904 may contain one or more data structures implementing the selected neural network architectural configuration itself, or it may contain an index or other identifier of the selected neural network architectural configuration so that the UE 104 can access the selected neural network architectural configuration from a local datastore or from a remote server. In other embodiments, the neural network management module 218 of the UE 104 selects the neural network architectural configurations to implement at the RRM NN 112 based on the current sensor/measurement configuration of the UE 104 independent of direction from the serving BS 110-1.

In response to the NN configuration message 904 or in response to the selection of its own neural network architectural configuration, at block 712 the UE 104 implements the indicated neural network architectural configuration at the RRM NN 112 of the UE 104. After the RRM NN 112 is thus initialized, the UE 104 can proceed with RRM management at the UE 104 based on the RRM actions 118 indicated by the output of the RRM NN 112. Accordingly, for an iteration of an input/output loop using the RRM NN 112, at block 714 the sensor set 210 provides a sensor data set 914 (one embodiment of local sensor data 114, FIG. 1) representative of sensor data captured by one or more sensors as an input to the RRM NN 112 of the UE 104, and, concurrently, at block 716 the RRM module 222 and the RF front end 202 of the UE 104 together obtain one or more radio measurements and provide these radio measurements as a radio measurements data set 916 (one embodiment of radio measurements data 116, FIG. 1) as another input to the RRM NN 112. In some embodiments, these data sets 914 and 916 represent samples from a single time slice. For example, the UE 104 may provide a separate sensor data set 914 and radio measurements data set 916 every 10 milliseconds (ms). In other embodiments, one or both of these data sets is a sequence of sampled data over multiple time slices in a sliding window, such as a sequence of 10 separate data sets obtained every 100 ms over the previous 1 second of time.

At block 718, the RRM NN 112 processes these inputs, and, in some embodiments, additional inputs such as the present RRC state or the present 5G NR mode, to generate an output representative of one or more RRM actions 918 (one embodiment of the RRM action 118, FIG. 1) based on the present neural network architectural configuration and present state of the nodes of the RRM NN 112. At block 720, the RRM module 222 of the UE 104 initiates implementation of the RRM action(s) 918, such as by triggering the performance of an RRM measurement or other RRM process by the RF front end 202, directing the RF front end 202 to forgo one or more scheduled RRM measurements or other RRM processes, reconfiguring one or more parameters of a scheduled RRM process, or a combination thereof.

Consistent with a typical RRM scheme, in at least one embodiment the UE 104 contributes to the RRM scheme of the wireless network 100 by providing RRM reporting to the serving BS 110-1, which the serving BS 110-1, the core network 106, or other infrastructure components can utilize in making RRM decisions for the wireless system as a whole. This RRM reporting can be performed in response to conventional RRM processes implemented at the UE 104, such as implementation of a static RRM measurement scheme separately from the RRM NN 112. This RRM reporting also can be performed in response to the performance of the RRM action(s) 918 by the UE 104. Thus, continuing the method 700 at FIG. 8, at block 722 the UE 104 provides RRM reporting 920 to the serving BS 110-1 in response to the performance of one or more RRM processes at the UE 104 due to RRM actions 918 generated by the RRM NN 112 or due to separate and parallel static RRM processes implemented at the UE 104. Typically, the RRM reporting 920 includes RRM measurement reports that include one or more RRM measurements performed by the UE 104 in the preceding period. For example, if the RRM action 918 generated at block 718 represented a directive to have the UE 104 perform a Licensed Assisted Access (LAA) survey, then as part of this LAA survey the UE 104 may identify a subset of neighboring cells and then perform radio measurements of this subset of cells, such as by measuring the RSRP or SINR of each cell in the subset. The RRM reporting 920 in this example thus may include an RRM measurement report containing the measured RSRP or measured SINR for each cell in this identified subset.

In response to the information contained in the RRM reporting 920, or in response to another trigger such as the expiration of a specified duration since the last update, the serving BS 110-1 may determine that it would be an appropriate point to update the underlying architectural configuration employed in the RRM NN 112. This update process typically relies on utilizing the same real-world inputs provided to the RRM NN 112 at a test UE implemented at the serving BS 110-1 (as described above), and then iteratively back-propagating any errors between the actual result output by the test UE and the expected or intended result. Accordingly, at block 724 the serving BS 110-1 sends a sensor/radio request 922 (FIG. 9) to the UE 104 to request that the UE 104 provide a copy of some or all of the sensor data sets 914 and radio measurement data sets 916 input to the RRM NN 112 since, for example, the last update process. In response to the sensor/radio request 922, at block 726 the UE 104 transmits the requested sensor/radio measurement data 924 (FIG. 9) to the serving BS 110-1. In another embodiment, rather than buffering the sensor data and radio measurement data for transmission to the serving BS 110-1 on request and in a single burst, the UE 104 can transmit a copy of each sensor data set 914 and/or a copy of each radio measurements data set 916 to the serving BS 110-1 as they are generated or otherwise in parallel with provision of these data sets as inputs to the RRM NN 112.

At block 728, the training module 312 of the serving BS 110-1 utilizes the received sensor data and/or radio measurements data from the UE 104 and performs a neural network update process 926 to retrain or otherwise update a test copy of the RRM NN 112 implemented as a test UE by the training module 312 by providing this data as inputs to the RRM NN 112 and revising the underlying neural network architectural configuration of the test copy based on a comparison of the resulting outputs with expected or intended outputs. This training further can include evaluation of the RRM reporting 920 recited in the period associated with the re-training data to evaluate the correctness of the operation of the RRM NN 112 at the UE 104 and adjust or otherwise revise the neural network architectural configuration of the test copy as a result. Thereafter, the neural network management module 310 of the serving BS 110-1 can extract the updated neural network architectural configuration from the re-trained test copy and provide the resulting updated neural network architectural configuration 324 to the RRM module 314 to replace or supplement the previous version in the datastore 602, as well as to transmit, at block 730, an update message 928 containing a representation of the updated neural network architectural configuration 324 to the UE 104. At block 732, the UE 104 updates the RRM NN 112 using the updated neural network architectural configuration 324 represented in the update message 928, either by replacing the “old” neural network architectural configuration of the RRM NN 112 with the updated version or using the updated version to selectively modify or augment the previous version of the RRM NN 112.

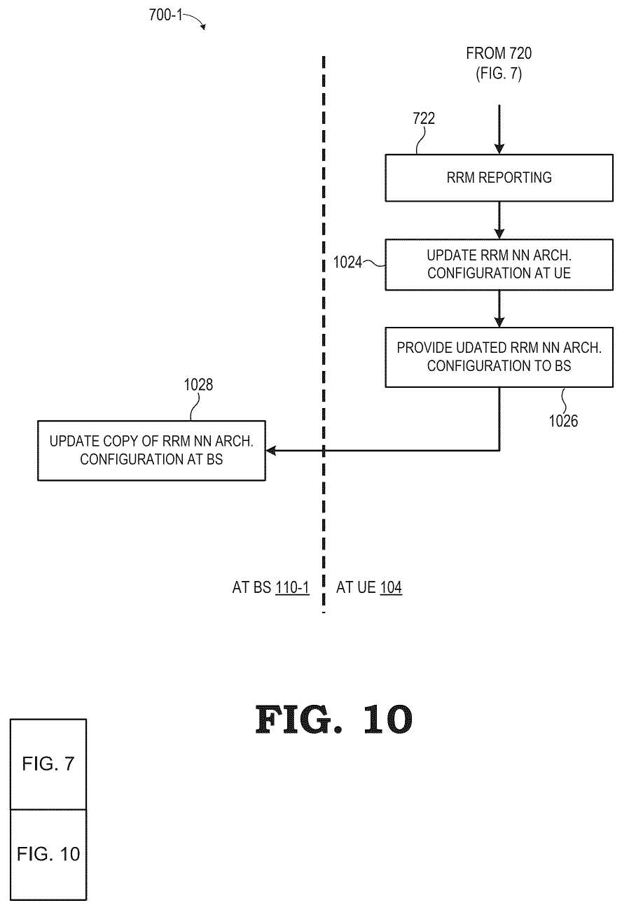

Referring to FIG. 10, an alternative implementation of the method 700, referred to as method 700-1, is depicted. Method 700-1 proceeds in the same manner as method 700 with respect to the process of blocks 702 to 720 of FIG. 7 and block 722 of FIG. 8. However, following the RRM reporting process of block 722, in method 700-1 the UE 104 performs the NN update process and reports the updated neural network architectural configuration to the serving BS 110-1, rather than the other way around. Accordingly, in method 700-1, following the RRM reporting of block 722, at block 1024 the neural network management module 218 of the UE 104 instantiates a copy of the RRM NN 112 as a training copy and then evaluates some or all of the output RRM actions 118 generated from the input sets of sensor data and radio measurements data relative to a set of RRM actions that would have been expected or intended given the same inputs (these expected RRM actions being specified by, for example, training guidance provided by the network infrastructure 102). The neural network management module 218 then updates the underlying architectural configuration of training copy of the RRM NN 112 by, for example, iteratively backpropagating the errors between actual and expected RRM actions. At block 1026, the neural network management module 218 then extracts the resulting modified neural network architectural configuration of the test copy of the RRM NN 112 as an updated neural network architectural configuration and updates the actual RRM NN 112 using the updated neural network architectural configuration. At block 1028, this update likewise can be transmitted to the serving BS 110-1 for storage as a candidate neural network architectural configuration 324 and/or for propagation to one or more other UE 104 that are using the same original neural network architectural configurations at their respective RRM neural networks.

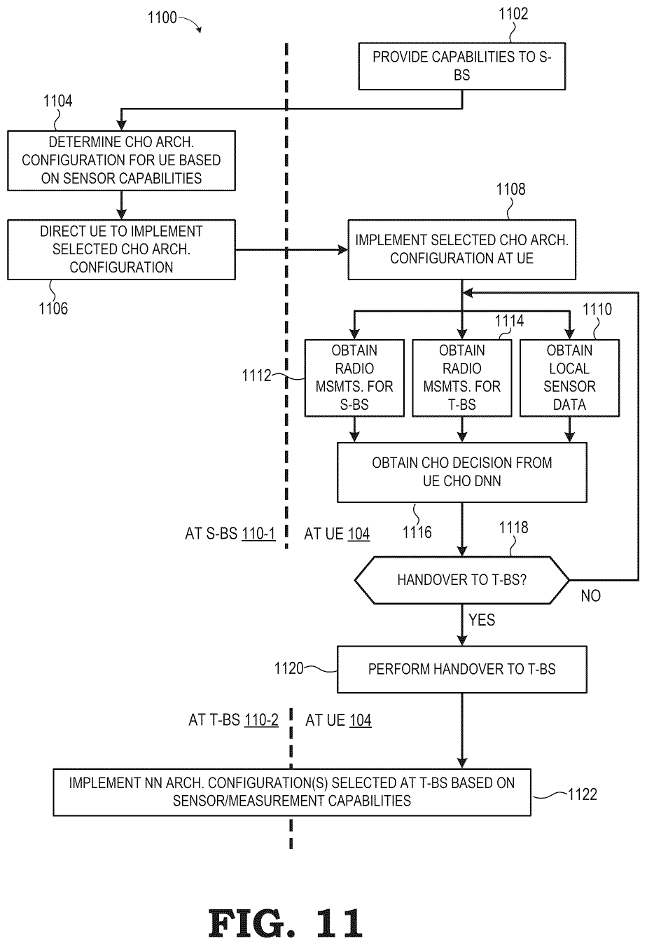

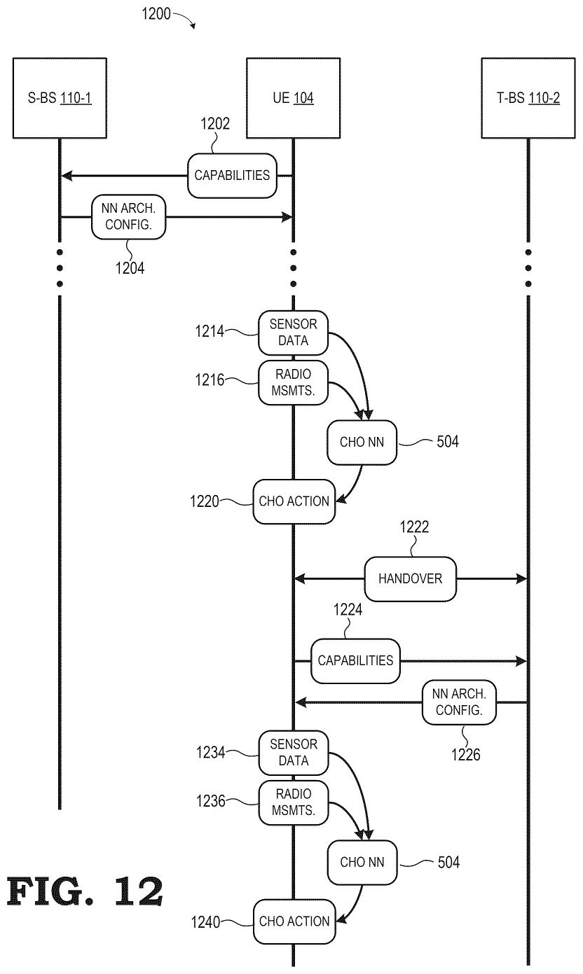

As explained above, the RRM NN 112 can provide control for implementing various conditional RRM procedures in which the network infrastructure 102 directs the UE 104 to conditionally perform an RRM-related process depending on the status of one or more conditions that the UE 104 is to monitor. CHO is one example of such conditional RRM processes, as a UE is directed to initiate a handover on the condition that one or more monitored conditions subsequently reach a corresponding threshold. In some embodiments, conditional RRM processes are represented in the same RRM NN 112 that provides other types of RRM decisioning at the UE 104. In other embodiments, one or more conditional RRM processes may be implemented as a separate conditional RRM neural network that operates in parallel with the RRM NN 112 and utilizes overlapping inputs. FIGS. 11 illustrates an example method 1100 of operation of a conditional RRM neural network, either as the RRM NN 112 (or the RRM processing module 502) or as a separate neural network, such as the CHO processing module 504. Note that the order of operations described with reference to method 1100 is for illustrative purposes only, and that a different order of operations may be performed, and further that one or more operations may be omitted or one or more additional operations included in the illustrated method. To facilitate understanding, the method 1100 is described with reference to an example implementation of the method 1100 reflected in a ladder diagram 1200 of FIG. 12.

The method 1100 initiates following training of a set of candidate CHO neural network architectural configurations using the training process described above. Thus, at block 1102 the UE 104 informs the serving BS 110-1 of its sensor capabilities and/or radio measurement capabilities by transmitting a sensor/measurement capabilities message 1202 (FIG. 12) to the serving BS 110-1. This message 1202 can include, for example, a UECapabilitiesInformation RRC message provided in response to a UECapabilitiesEnquiry RRC message from the serving BS 110-1. At block 1104, the neural network management module 310 of the serving BS 110-1 selects a candidate CHO neural network architectural configuration (e.g., one example of a neural network architectural configuration 324) from the set 322 based on one or both of the sensor capabilities advertised by the UE 104 or the radio measurement capabilities advertised by the UE 104. With a suitable CHO neural network architectural configuration selected, at block 1106 the serving BS 110-1 directs the UE 104 to implement the selected CHO neural network architectural configuration at the CHO processing module 504 by sending a CHO configuration message 1204 (FIG. 12) to the UE 104. The CHO configuration message 1204 may contain one or more data structures implementing the selected neural network architectural configuration itself, or it may contain an index or other identifier of the selected neural network architectural configuration so that the UE 104 can access the selected neural network architectural configuration from a local datastore or a remote server. In other embodiments, the neural network management module 218 of the UE 104 selects the CHO neural network architectural configurations to implement at the CHO processing module 504 based on the current sensor/measurement configuration of the UE 104 independent of direction from the serving BS 110-1.

In response to the CHO configuration message 1204 or in response to the selection of its own CHO neural network architectural configuration, at block 1108 the UE 104 implements the indicated CHO neural network architectural configuration at the CHO processing module 504 and thus concluding the initialization of the CHO processing module 504.

The UE 104 then can proceed with conditional RRM management at the UE 104 based on the CHO actions 520 indicated by the output of the CHO processing module 504. Accordingly, for an iteration of an input/output loop using the CHO processing module 504, at block 1110 the sensor set 210 provides a sensor data set 1214 (FIG. 12)(one embodiment of local sensor data 114, FIG. 1) representative of sensor data captured by one or more sensors as an input to the CHO processing module 504. As will be appreciated, the decision to initiate a handover as a result of a CHO directive typically reflects the results of a comparison of the suitability of the present serving cell relative to one or more neighboring, or target, cells, where the suitability is indicated by a comparison of various radio measurements of the serving cell and the neighboring cell(s). As such, concurrent with the provision of an iteration of sensor data, at block 1112 the RRM module 222 and the RF front end 202 of the UE 104 together obtain one or more radio measurements for the serving BS 110-1 and at block 1114 the RRM module 22 and the RF front end 202 obtain one or more radio measurements for each applicable neighboring BS 110, such as target BS 110-2, and provide these radio measurements as a radio measurements data set 1216 (FIG. 12)(one embodiment of radio measurements data 116, FIG. 1) as another input to the CHO processing module 504. In some embodiments, these data sets 1214, 1216 represent samples from a single time slice, while in other embodiments, one or both of these data sets is a sequence of sampled data over multiple time slices in a sliding window.

At block 1116, the CHO processing module 504 processes these inputs, and, in some embodiments, additional inputs such as the present RRC state or the present 5G NR mode, to generate an output representative of one or more CHO actions 1220 (FIG. 12)(one embodiment of the CHO action 520, FIG. 5) based on the present neural network architectural configuration and present state of the nodes of the CHO processing module 504. The RRM module 222 of the UE 104 then initiates implementation of the CHO action(s) 1220. As described above, in some embodiments, the CHO action 1220 can include a process to adjust some parameters of the CHO process, such as changing a threshold used in making a handover decision. However, in other embodiments, the CHO action 1220 represents the handover decision itself. In such embodiments, at block 1118 the RRM module 222 determines the handover decision represented by the CHO action 1220. If the handover decision is to refrain from initiating a handover, then the method 1100 can return to blocks 1110, 1112, and 1114 for another iteration of the CHO action generation process using a new set of sensor and measurement data inputs to the CHO processing module 504.

Otherwise, if the handover decision is to initiate a handover, at block 1120 the RRM module 222 and the RF front end 202 coordinate to proceed with a handover 1222 (FIG. 12) to the indicated neighboring cell (represented in this example by the target BS 110-1). After the handover is performed, it will be appreciated that the UE 104 is now connected to a different cell that may have different RRM parameters compared to the previous cell associated with BS 110-1. Accordingly, in at least one embodiment, the configuration for at least one of the RRM NN 112 (as, for example, the RRM processing module 502) or the CHO processing module 504 is replaced with new configurations supplied by the BS 110-2 as the new serving BS for the UE 104. Accordingly, at block 1122 the same or similar neural network configuration process described above with reference to blocks 1102 to 1108 may be performed again, but this time with neural network architectural configuration(s) selected by and provided by the BS 110-2 instead of the BS 110-1. As such, the UE 104 can provide a representation of its sensor and/or radio measurement capabilities to the BS 110-2 as a capabilities message 1224 (FIG. 12), and the BS 110-2 can select a suitable neural network architectural configuration 1226 (FIG. 12) based on these capabilities and direct the UE 104 to implement the selected neural network architectural configuration 1226 for the CHO processing module 504.

Thereafter, the UE 104 can perform neural-network-based CHO decision-making process in the same manner as described above with the newly configured CHO processing module 504, including providing as inputs to the CHO processing module 504 a sensor data set 1234 (FIG. 12) obtained from the sensor set 210 and a radio measurement data set 1236 (FIG. 12). From these inputs, the CHO processing module 504 generates a CHO action 1240 suitable for the CHO-related RRM scheme implemented by the BS 110-2. The UE 104 then may implement the one or more CHO processes represented by the CHO action 1240 as described herein.

The embodiments of the present disclosure also may be better understood through consideration of the following non-limiting examples:

Example 1: A computer-implemented method, in a wireless device, including:
receiving a first set of sensor data from one or more sensors of the wireless device;
receiving a first set of radio measurements from a radio interface of the wireless device that is distinct from the one or more sensors;
processing the first set of sensor data and the first set of radio measurements at a radio resource management (RRM) neural network of the wireless device to generate a first output representative of a first RRM action; and
performing the first RRM action at the wireless device.

Example 2: The method of Example 1, wherein the wireless device is a user equipment and the method further includes:
providing at least one of a representation of sensor capabilities of the wireless device for receipt by an infrastructure component of a network infrastructure that is wirelessly connected to the wireless device;
receiving a first neural network architectural configuration from the infrastructure component in response to providing the representation of sensor capabilities; and implementing the first neural network architectural configuration at the RRM neural network.

Example 3: The method of Example 2, wherein the representation of sensor capabilities includes one or more fields of a UECapabilitiesInformation Radio Resource Control (RRC) message.

Example 4: The method of Example 2 or 3, further including:
providing at least one of the first set of sensor data or the first set of radio measurements to the infrastructure component;
receiving a second neural network architectural configuration from the infrastructure component in response to providing the at least one of the first set of sensor data or the first set of radio measurements, the second neural network architectural configuration representing a modification of the first neural network architectural configuration based on the at least one of the first set of sensor data or the first set of radio measurements; and
implementing the second neural network architectural configuration at the RRM neural network.

Example 5: The method of Example 2 or 3, further including:
modifying the first neural network architectural configuration based on at least one of the first set of sensor data or the first set of radio measurements to generate a second neural network architectural configuration; and
implementing the second neural network architectural configuration at the RRM neural network.

Example 6: The method of any of Examples 1 to 5, further including:
receiving a representation of an operational state of the wireless device; and
wherein processing includes processing the first set of sensor data, the first set of radio measurements, and the operational state at the RRM neural network to generate the first output.

Example 7: The method of Example 6, wherein the operational state includes a radio resource control (RRC) state of the wireless device.

Example 8: The method of any of Examples 1 to 7, wherein the one or more sensors include at least one of: a positional sensor; a pose sensor; an accelerometer, a pressure sensor; or a proximity sensor.

Example 9: The method of Example 8, wherein the positional sensor includes at least one of a satellite-based positioning sensor or a visual-telemetry imaging sensor and the pose sensor includes at least one of a gyroscope or a visual-telemetry imaging sensor.

Example 10: The method of any of Examples 1 to 9, wherein the first set of radio measurements includes at least one signal power measurement of a serving cell or a neighboring cell.

Example 11: The method of Example 10, wherein the signal power measurement includes at least one of a signal-to-noise (SNR) measurement, a signal-to-interference-plus-noise (SINR) measurement, a reference signal received power (RSRP) measurement, or a received signal strength indication (RSSI) measurement.

Example 12: The method of any of Examples 1 to 11, wherein the RRM action includes at least one of: performing an RRM-related measurement by the wireless device; configuring a characteristic of an RRM-related measurement to be performed by the wireless device; or performing an RRM reporting process at the wireless device.

Example 13: The method of Example 12, wherein the RRM-related measurement includes at least one of: an inter-frequency measurement; an intra-frequency measurement; or an inter-radio access technology (RAT) measurement.

Example 14: The method of Example 12 or 13, wherein the characteristic of the RRM-related measurement includes at least one of: a frequency or timing of the RRM-related measurement or a frequency band or channel of the RRM-related measurement.

Example 15: The method of Example 1, wherein the RRM action includes execution of a conditional handover (CHO) decision or a Conditional PSCell change (CPC) decision.

Example 16: The method of Example 15, further including:
responsive to connecting to a cell as a result of a conditional handover decision:
providing a representation of sensor capabilities of the wireless device for receipt by an infrastructure component of the cell;
receiving a first neural network architectural configuration from the infrastructure component of the cell in response to providing the representation of sensor capabilities; and
replacing a second neural network architectural configuration of the RRM neural network with the first neural network architectural configuration.

Example 17: The method of Example 16, further including:
receiving a second set of sensor data from the one or more sensors of the wireless device;
receiving a second set of radio measurements from the radio interface of the wireless device;
processing the second set of sensor data and the second set of radio measurements at the RRM neural network of the wireless device to generate a second output representative of a second RRM action; and
performing the second RRM action at the wireless device.

Example 18: The method of any of Examples 1 to 17, wherein the wireless device is a user equipment.

Example 19: The method of Example 1, wherein the wireless device is a base station.

Example 20: The method of Example 19, further including: receiving RRM reporting from a user equipment.

Example 21: A wireless device including:
a radio interface;
at least one processor coupled to the radio interface; and
at least one memory coupled to the at least one processor, the at least one memory storing executable instructions configured to manipulate the at least one processor to perform the method of any of Examples 1 to 20.

Example 22: A computer-implemented method, in an infrastructure component wirelessly connected to a wireless device, including:
receiving, from the wireless device, a representation of sensor capabilities of the wireless device;
determining a first neural network architectural configuration based on the representation of sensor capabilities; and
transmitting a representation of the first neural network architectural configuration to the wireless device for implementation at a radio resource management (RRM) neural network of the wireless device for determining RRM actions to be performed by the wireless device.

Example 23: The method of Example 22, further including:
receiving at least one of a set of sensor data or a set of radio measurements from the wireless device;
modifying the first neural network architectural configuration based on the at least one of the set of sensor data or the set of radio measurements to generate a second neural network architectural configuration; and
transmitting a representation of the second neural network architectural configuration to the wireless device for implementation at RRM neural network of the wireless device.

Example 24: The method of Example 22 or 23, wherein the set of sensor data includes at least one of: positional data; pose data; acceleration data; barometric pressure or elevation data; or proximity data.

Example 25: The method of any of Examples 22 to 24, wherein the set of radio measurements includes at least one signal power measurement of a serving cell or a neighboring cell.

Example 26: The method of any of Examples 22 to 25, wherein the determined RRM actions include at least one of: performing an RRM-related measurement by the wireless device or configuring a characteristic of an RRM-related measurement to be performed by the wireless device.

Example 27: The method of any of Examples 22 to 26, wherein the determined RRM actions include execution of a conditional handover decision.

Example 28: The method of any of Examples 22 to 26, wherein the infrastructure component includes a base station.

Example 29: The method of any of Examples 22 to 28, wherein the wireless device includes a user equipment.

Example 30: The method of any of Examples 22 to 29, wherein the representation of sensor capabilities includes one or more fields of a UECapabilitiesInformation Radio Resource Control (RRC) message.

Example 31: An infrastructure component including:
a set of one or more sensors;
a radio interface distinct from the set of one or more sensors;
at least one processor coupled to the radio interface; and
at least one memory coupled to the at least one processor, the at least one memory storing executable instructions configured to manipulate the at least one processor to perform the method of any of Examples 22 to 30.

In some embodiments, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or another instruction format that is interpreted or otherwise executable by one or more processors.

A computer-readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A computer-implemented method, in a wireless device, comprising:
receiving a first set of sensor data from one or more sensors of the wireless device;
receiving a first set of radio measurements from a radio interface of the wireless device that is distinct from the one or more sensors;
processing the first set of sensor data and the first set of radio measurements at a radio resource management (RRM) neural network of the wireless device to generate a first output representative of a first RRM action; and
performing the first RRM action at the wireless device.

2. The method of claim 1, wherein the wireless device is a user equipment and the method further comprises:
providing at least one of a representation of sensor capabilities of the wireless device for the one or more sensors for receipt by an infrastructure component of a network infrastructure that is wirelessly connected to the wireless device;
receiving a first neural network architectural configuration from the infrastructure component in response to providing the representation of sensor capabilities; and
implementing the first neural network architectural configuration at the RRM neural network.

3. The method of claim 2, wherein the representation of sensor capabilities comprises one or more fields of a UECapabilitiesInformation Radio Resource Control (RRC) message.

4. The method of claim 2, further comprising:
providing at least one of the first set of sensor data or the first set of radio measurements to the infrastructure component;
receiving a second neural network architectural configuration from the infrastructure component in response to providing the at least one of the first set of sensor data or the first set of radio measurements, the second neural network architectural configuration representing a modification of the first neural network architectural configuration based on the at least one of the first set of sensor data or the first set of radio measurements; and
implementing the second neural network architectural configuration at the RRM neural network.

5. The method of claim 2, further comprising:
modifying the first neural network architectural configuration based on at least one of the first set of sensor data or the first set of radio measurements to generate a second neural network architectural configuration; and
implementing the second neural network architectural configuration at the RRM neural network.

6. The method of claim 1, further comprising:
receiving a representation of an operational state of the wireless device; and
wherein processing comprises processing the first set of sensor data, the first set of radio measurements, and the operational state at the RRM neural network to generate the first output.

7. The method of claim 6, wherein the operational state comprises a radio resource control (RRC) state of the wireless device.

8. The method of claim 1, wherein the one or more sensors comprise at least one of: a positional sensor; a pose sensor; an accelerometer, a pressure sensor; or a proximity sensor.

9. The method of claim 1, wherein the first set of radio measurements comprises at least one signal power measurement of a serving cell or a neighboring cell.

10. The method of claim 1, wherein the RRM action comprises at least one of: performing an RRM-related measurement by the wireless device; configuring a characteristic of an RRM-related measurement to be performed by the wireless device; or performing an RRM reporting process at the wireless device.

11. The method of claim 10, wherein the characteristic of the RRM-related measurement comprises at least one of: a frequency or timing of the RRM-related measurement or a frequency band or channel of the RRM-related measurement.

12. The method of claim 1, wherein the RRM action comprises execution of a conditional handover (CHO) decision or a Conditional PSCell change (CPC) decision.

13. The method of claim 12, further comprising:
responsive to connecting to a cell as a result of a conditional handover decision:
providing a representation of sensor capabilities of the wireless device for receipt by an infrastructure component of the cell;
receiving a first neural network architectural configuration from the infrastructure component of the cell in response to providing the representation of sensor capabilities; and
replacing a second neural network architectural configuration of the RRM neural network with the first neural network architectural configuration.

14. The method of claim 13, further comprising:
receiving a second set of sensor data from the one or more sensors of the wireless device;
receiving a second set of radio measurements from the radio interface of the wireless device;
processing the second set of sensor data and the second set of radio measurements at the RRM neural network of the wireless device to generate a second output representative of a second RRM action; and
performing the second RRM action at the wireless device.

15. The method of claim 1, wherein the wireless device is a user equipment or a base station.

16. (canceled)

17. (canceled)

18. A wireless device comprising:
one or more sensors;
a radio interface distinct from the one or more sensors;
at least one processor coupled to the radio interface; and
at least one memory coupled to the at least one processor, the at least one memory storing executable instructions configured to manipulate the at least one processor to:
receive a first set of sensor data from the one or more sensors;
receive a first set of radio measurements from the radio interface;
process the first set of sensor data and the first set of radio measurements at a radio resource management (RRM) neural network to generate a first output representative of a first RRM action; and
perform the first RRM action at the wireless device.

19. The wireless device of claim 18, wherein the wireless device is a user equipment and the executable instructions are further configured to manipulate the at least one processor to:
provide at least one of a representation of sensor capabilities of the wireless device for the one or more sensors for receipt by an infrastructure component of a network infrastructure that is wirelessly connected to the wireless device;
receive a first neural network architectural configuration from the infrastructure component in response to providing the representation of sensor capabilities; and
implement the first neural network architectural configuration at the RRM neural network.

20. The wireless device of claim 19, wherein the executable instructions are further configured to manipulate the at least one processor to:
provide at least one of the first set of sensor data or the first set of radio measurements to the infrastructure component;
receive a second neural network architectural configuration from the infrastructure component in response to providing the at least one of the first set of sensor data or the first set of radio measurements, the second neural network architectural configuration representing a modification of the first neural network architectural configuration based on the at least one of the first set of sensor data or the first set of radio measurements; and
implement the second neural network architectural configuration at the RRM neural network.

21. The wireless device of claim 19, wherein the executable instructions are further configured to manipulate the at least one processor to:
modify the first neural network architectural configuration based on at least one of the first set of sensor data or the first set of radio measurements to generate a second neural network architectural configuration; and
implement the second neural network architectural configuration at the RRM neural network.

22. The wireless device of claim 18, wherein the RRM action comprises execution of a conditional handover (CHO) decision or a Conditional PSCell change (CPC) decision, and wherein the executable instructions are further configured to manipulate the at least one processor to:
responsive to connecting to a cell as a result of a conditional handover decision:
provide a representation of sensor capabilities of the wireless device for receipt by an infrastructure component of the cell;
receive a first neural network architectural configuration from the infrastructure component of the cell in response to providing the representation of sensor capabilities; and
replace a second neural network architectural configuration of the RRM neural network with the first neural network architectural configuration.
